(19) United States
(12) Patent Application Publication
(10) Pub. No.: US 2026/0349174 A1
(43) Pub. Date: Nov. 5, 2026

(54) ELECTRO-OPTICAL APPARATUS INCLUDING INTERPOSED MODULATOR

(71) Applicant: Taiwan Semiconductor Manufacturing Co., Ltd., Hsinchu (TW)

(72) Inventor: Chan-Hong Chern, Palo Alto, CA (US)

(21) Appl. No.: 19/197,016

(22) Filed: May 2, 2025

(51) Int. Cl. G02B 6/13; G02B 6/12

(52) U.S. Cl. CPC G02B 6/13; G02B 6/12004; G02B 2006/12142

(57) ABSTRACT

In some embodiments, a device is described that includes an interposed modulator including a modulator on modulator interposer and a dielectric layer over the modulator; a Photonic Integrated Circuit (PIC) die having a waveguide for optical communication between the interposed modulator and the PIC die; and an Electrical Integrated Circuit (EIC) die in electrical communication with the PIC die and the interposed modulator through bonded interfaces.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a side cross-sectional view illustrating one embodiment of an optical module including an Electrical Integrated Circuit (EIC) die, Photonics Integrated Circuit (PIC) and interposed modulator, in accordance with some embodiments;

FIG. 2 is a side cross-sectional view illustrating forming thin lithium niobate layer from a donor substrate, in accordance with some embodiments;

FIG. 3 is a side cross-sectional view illustrating bonding the donor substrate to a modulator interposer, in accordance with some embodiments;

FIG. 4 is a side cross-sectional view illustrating separation (also referred to as cleaving) of a lithium niobate layer from the donor substrate, in accordance with some embodiments;

FIG. 5 is a side cross-sectional view that illustrates photolithography and etching processes to form a modulator from the lithium niobate layer, in accordance with some embodiments;

FIG. 6 is a top down view of the modulator being configured as a Mach-Zehnder modulator, in accordance with some embodiments;

FIG. 7A is a top down view illustrating the modulator being configured as a ring modulator, in accordance with some embodiments;

FIG. 7B is a side cross-sectional view of the modulator depicted in FIG. 7A along section line A-A, in accordance with some embodiments;

FIG. 8 is a side cross-sectional view illustrating further processing of the modulator module that includes forming a dielectric layer/cladding layer over the modulator, in accordance with some embodiments;

FIG. 9 is a side cross-sectional view illustrating interposed modulator that is bonded to the PIC die of an optical module, in accordance with some embodiments;

FIG. 10 is a top down view illustrating a modulator edge coupler leading into a waveguide portion of a modulate edge coupler that is overlying a waveguide portion of the modulator, in accordance with some embodiments;

FIG. 11A is a side cross-sectional view along section line B-B of FIG. 9 illustrating a phase shifter portion of the modulator, in accordance with some embodiments;

FIG. 11B is a side cross-sectional view illustrating section line B-B of FIG. 9 illustrating a modulator including two phase shifter portions, in accordance with some embodiments;

FIG. 12 is a side cross-sectional view illustrating an interposed modulator that is bonded to the PIC die of an optical module, in which the optical fiber is connected to the waveguide of the modulator, in accordance with some embodiments;

FIG. 13 is a side cross-sectional view illustrating an interposed modulator that is bonded to the PIC die of an optical module, in which the optical fiber is connected to an edge coupler within the interposed modulator, in accordance with some embodiments;

FIG. 14 is a side cross-sectional view illustrating an interposed modulator that is bonded to the PIC die of an optical module, in which the optical fiber is connected to a backside edge coupler within the PIC die, in accordance with some embodiments;

FIG. 15 is a side cross-sectional view illustrating an interposed modulator that is bonded to the PIC die of an optical module, in which the optical fiber is connected to an edge coupler within the interposed modulator and a waveguide is positioned between the backside edge coupler in the PIC die and the interposed modulator, in accordance with some embodiments;

FIG. 16 is a side cross-sectional view illustrating an interposed modulator that is bonded to the PIC die of an optical module, in which the optical fiber is connected to a frontside edge coupler within the PIC die, in accordance with some embodiments;

FIG. 17 is a side cross-sectional view illustrating an interposed modulator that is bonded to the PIC die of an optical module, in which the optical fiber is connected to a grating coupler within the PIC die, in accordance with some embodiments;

FIG. 18 is a side cross-sectional view of an interposed modulator formed on the backside of the optical components in a PIC die, in which an edge coupler is integrated into a supporting interposer, in accordance with some embodiments;

FIG. 19 is a side cross-sectional view of an interposed modulator formed on the backside of the optical components in a PIC die, in which an edge coupler is positioned between the modulator and the optical components in the PIC die, in accordance with some embodiments;

FIG. 20 is a side cross-sectional view illustrating an embodiment of an optical module including a vertically stacked EIC die, PIC die and interposed modulator that is packaged in a three-dimensional (3D) electro optical package, in accordance with some embodiments;

FIG. 21 is a side cross-sectional view illustrating bonding an optical module to a redistribution layer (RDL) substrate, in accordance with some embodiments;

FIG. 22 is a side cross-sectional view illustrating bonding the redistribution layer substrate to a packaging substrate, in accordance with some embodiments;

FIG. 23A is a top down view illustrating an electro optical package including a PIC die, interposed modulator and EIC die that are co-plane and heterogeneously integrated on an interposer substrate, in accordance with some embodiments;

FIG. 23B is a side cross-sectional view of the electro optical package illustrated in FIG. 23A, in accordance with some embodiments;

FIG. 24A is a top down view illustrating an electro optical package including a PIC die, interposed modulator and EIC die that are co-plane and arranged in-line on an interposer substrate, in accordance with some embodiments; and

FIG. 24B is a side cross-sectional view of the electro optical package illustrated in FIG. 24A, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In three dimensionally (3D) packaged devices, while optical transmission may be able to transmit and receive high-frequency data, some key optical components, e.g., the modulator, in silicon photonics are not able to meet continuously increased bandwidth demands. For example, the highest data rate a silicon-based modulator, such as Mach-Zehnder Modulator or Micro-Ring Modulator, can support is approximately 200 GB/s per wavelength (l) and per channel. However, in some applications it would be advantageous to support data rate transfer rates as great as approximately 400 GB/s per wavelength (l) and per channel. Lithium Niobate (LiNbO₃) modulators show some promising characteristics of transmission rates greater than approximately 400 GB/s light modulation. However, lithium niobate modulators that are external devices from the optical module including the Electrical Integrated Circuit (EIC) die and the Photonics Integrated Circuit (PIC) die can be bulky devices that present challenges for system integration. Additionally, when the lithium niobate modulators are separate from the optical module of the EIC/PIC die, the electrical signals may need to travel long distances between the optical module and the lithium niobate modulator. The distance that the electrical signal travels between the modulator and the EIC/PIC die may result in efficiency loss in the electrical signal transmission, in which the distance that the signal travels may limit the modulation bandwidth. In some embodiments, the methods and structures of the present disclosure integrate high-bandwidth modulator, e.g. Thin-Film Lithium Niobate (TFLN) module, with the PIC die 250. In some embodiments, the TFLN module, which is damascened in a silicon (Si) (or organic, or glass) interposer, is bonded to the PIC die through fusion-bonding, direct-bonding or hybrid-bonding.

The embodiments presented herein are intended to be illustrative and are not intended to limit the ideas presented to the precise embodiments described. Rather, the ideas presented may be incorporated into a wide variety of embodiments, and all such embodiments may be included within the overall scope of the disclosure.

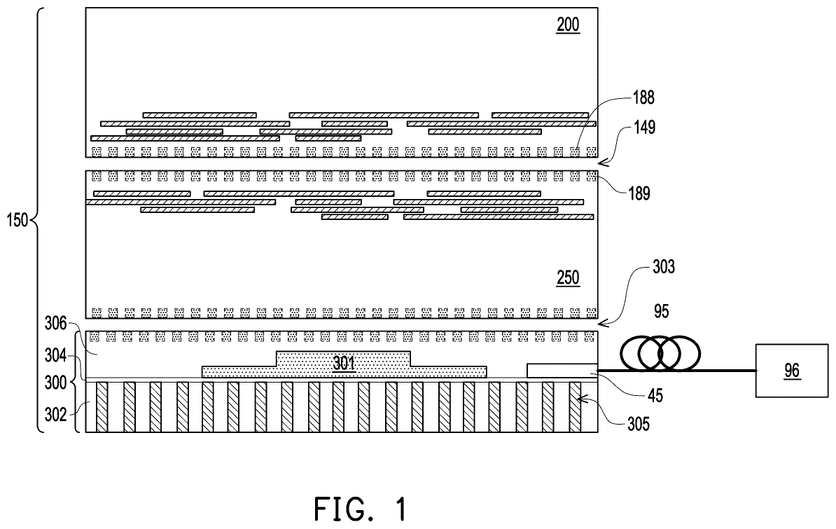

With reference now to FIG. 1, there is illustrated a side cross-sectional view of an optical module 150 including an EIC die 200 and a PIC die 250 that is bonded to a modulator module 300 including a modulator 301 that has ultra-high-bandwidth performance (e.g. Thin-Film Lithium Niobate (TFLN module). In some embodiments, the modulator 301, which is damascened in a silicon (Si) (or organic, or glass) interposer, is bonded to the PIC die 250 through the PIC to modulator module bond 303, which may be provided by fusion-bonding and/or hybrid-bonding. In some embodiments, a continuous-wave (CW) light 96 is coupled to the modulator module 300 by a modulator edge coupler 45. In some embodiments, the EIC die 200 and the PIC die 250 is coupled through fusion-bonding, direct-bonding, hybrid-bonding, or microbumps. In some embodiments, relatively-lower high-frequency signals, low-frequency signals, power signals are coupled through the vias 305 to communicate with the PIC die 250 and the EIC die 200. High-frequency signals between the EIC die 200 and the PIC die 250 are coupled through direct-bonds, hybrid-bond or microbumps at the EIC to PIC bond 149.

In the embodiment depicted in FIG. 1, the EIC die 200 is bonded atop the PIC die 250. In some embodiments, the EIC die 200 can use electrical signals to transmit and/or process data. The EIC die 200 is a chip that uses electronic components like semiconductor devices to process data. The semiconductor devices employed by the EIC die 200 described herein can be silicon semiconductor devices, germanium containing semiconductor devices, e.g., silicon germanium (SiGe) channel semiconductor devices, and/or III-V semiconductor devices.

Embodiments, have been contemplated in which the semiconductor devices of the EIC die 200 are silicon channel semiconductor devices. Being a silicon channel semiconductor device means that the channel region of the semiconductor device is silicon. Embodiments have been contemplated in which the semiconductor devices of the EIC die 200 are silicon germanium channel semiconductor devices. By being a silicon germanium channel semiconductor device at least the channel region of the semiconductor device is composed of silicon germanium. Embodiments have been contemplated in which the semiconductor devices of the EIC die 200 are semiconductor devices in which the channel of the device is provided by a type III-V semiconductor material.

In some embodiments, the EIC die 200 includes at least one semiconductor device that includes a channel region, such as a field effect transistor (FET). Each transistor includes source/drain regions doped to a p-type or n-type conductivity on opposing sides of the channel region. Conductivity across the channel region is controlled by a gate structure that is on the channel region. By being based on a type III-V material, silicon material or silicon germanium (SiGe), the channel region of a semiconductor device is composed of the type III-V semiconductor material, silicon or silicon germanium (SiGe). In some embodiments, the semiconductor devices in the EIC die 200 may include field effect transistors, p-type transistors, n-type transistors, bipolar junction transistors, fin field effect transistors (FinFETs), planar transistors, nano-FETs, combinations thereof, or the like. It is noted that the aforementioned description of semiconductor device types for the EIC die 200 are provided for illustrative purposes only, and are not intended to limit the present disclosure.

A type III-V semiconductor material is composed of elements from group III and group V of the periodic table of elements. In one embodiment, at least one transistor in the EIC die 200 is comprised of at least one type III-V semiconductor material selected from the group consisting of aluminum antimonide (AlSb), aluminum arsenide (AlAs), aluminum nitride (AlN), aluminum phosphide (AlP), gallium arsenide (GaAs), gallium phosphide (GaP), indium antimonide (InSb), indium arsenic (InAs), indium nitride (InN), indium phosphide (InP), aluminum gallium arsenide (AlGaAs), indium gallium phosphide (InGaP), aluminum indium arsenic (AlInAs), aluminum indium antimonide (AlInSb), gallium arsenide nitride (GaAsN), gallium arsenide antimonide (GaAsSb), aluminum gallium nitride (AlGaN), aluminum gallium phosphide (AlGaP), indium gallium nitride (InGaN), indium arsenide antimonide (InAsSb), indium gallium antimonide (InGaSb), aluminum gallium indium phosphide (AlGaInP), aluminum gallium arsenide phosphide (AlGaAsP), indium gallium arsenide phosphide (InGaAsP), indium arsenide antimonide phosphide (InArSbP), aluminum indium arsenide phosphide (AlInAsP), aluminum gallium arsenide nitride (AlGaAsN), indium gallium arsenide nitride (InGaAsN), indium aluminum arsenide nitride (InAlAsN), gallium arsenide antimonide nitride (GaAsSbN), gallium indium nitride arsenide aluminum antimonide (GaInNAsSb), gallium indium arsenide antimonide phosphide (GaInAsSbP), and combinations thereof.

In comparison to complementary metal oxide semiconductor (CMOS) device based upon a silicon (Si) channel, a similar arrangement of type III-V semiconductor-based material can provide increased carrier mobility, e.g., increased electron mobility. The III-V semiconductor-based transistors when employed as the transistors of the EIC die 200 may result in high electrical transmission rates being greater than 200 GB/s. For example, electrical transmission rates can be increased to 400 GB/s or greater by implementing III-V semiconductor-based transistors into the EIC die 200. In comparison, an EIC die 200 employing silicon (Si) based transistors, such as pure silicon (Si) CMOS, have an electrical transmission rate limited to 200 GB/s or less.

Silicon germanium (SiGe) based transistors also have an increased carrier mobility when compared to silicon (Si) based transistors. The increased carrier mobility results from the band gap of silicon germanium (SiGe). More particularly, SiGe utilizes a heterojunction structure, where the addition of germanium to silicon creates a different bandgap, allowing for improved carrier transport. Similar to III-V semiconductor-based transistors, when silicon germanium-based transistors are employed as the transistors of the EIC die 200 an increased electrical transmission rate may be achieved when compared to the electrical transmission rate of silicon-based transistors. For example, electrical transmission rates can be increased to 400 GB/s or greater by implementing SiGe semiconductor-based transistors into the EIC die 200.

The PIC die 250 receives, modulates, and transmits optical (e.g., light) signals. For example, the PIC die 250 uses optical components like waveguides and lasers to manipulate light for data transmission, essentially operating on photons instead of electrons. In addition to waveguides and lasers, the PIC die 250 further includes modulators and detectors. For example, the PIC die 250 may include O-E/E-O converters, a modulation driver, and transimpedance amplifier (TIA). Electro-optic (EO) modulation in photonics is a process that changes the optical properties of a material using an electric field.

The PIC die 250 may be connected to the EIC die 200 through at least one EIC to PIC bond 149 provided by microbumps, hybrid bonding, copper to copper bonding, and/or direct/fusion covalent bonds. In some embodiments, in which the EIC to PIC bond 149 is provided by a microbump, the microbump bond may be provided by a process that includes forming raised metal bumps on the bonding surfaces of the EIC die 200 and the PIC die 250, which act as electrical connection points for connecting multiple chips or layers within an integrated circuit package, allowing for high-density interconnections and enabling 3D stacking. In some embodiments, the microbumps that provides the EIC to PIC bond 149 may be composed of metals like copper, with a solder cap for improved reliability. In some embodiments, methods for forming the microbumps include electroplating, photolithography, and screen printing. In some embodiments, the microbumps may have a diameter ranging from 20 microns to 30 microns.

In some embodiments, the EIC to PIC bond 149 is provided by copper-to-copper bonding and/or hybrid bonding. The copper-to-copper bonding method can include preparing the surfaces of the copper pads 188, 189 on each die, e.g., the EIC die 200 and the PIC die 250, are prepared and cleaned to ensure a strong bond. The copper-to-copper bonding method also includes aligning the dies so that the copper pads 188, 189 on each die (the EIC die 200 and the PIC die 250) match up. In a following process sequence, the copper-to-copper bonding method involves the dies (the EIC die 200 and the PIC die 250) being pressed together, and the copper pads 148, 248 bonding through a process of diffusion, creating a direct electrical connection. In some embodiments, the EIC to PIC bond 149 provided by the copper-to-copper bonding can be achieved with bond pads as small as 0.25 μm at a pitch of 0.5 μm. In some embodiments, dielectric material between the bond pads of each of the structures being bonded to one another also form bonds when brought into contact with one another during the process by which the copper-to-copper bonds form. The bonding resulting from the copper-to-copper bonds and the dielectric material to dielectric material bonds results in a hybrid bond.

In yet another embodiment, the EIC to PIC bond 149 may be provided by direct bonding/covalent fusion bonding. Covalent fusion bonding is to a type of bonding process where two surfaces are joined together through the formation of strong covalent bonds. Covalent fusion bonding is a direct bonding method where no additional intermediate layers are needed, relying solely on the chemical bonds between the surfaces. Covalent fusion bonding may include surface preparation techniques to enhance the formation of covalent bonds, sometimes including a pre-bonding step at room temperature followed by a high-temperature annealing process to fully establish the bonds.

FIG. 1 illustrates that the modulator module 300 is bonded to the PIC die 250 through a PIC to modulator module bond 303. The modulator module 300 includes a modulator 301 that is formed on a modulator interposer 302. In an optical device, the modulator 301 controls the properties of a light beam, like its intensity, phase, or polarization, by manipulating these characteristics based on an applied electrical signal, essentially “encoding” information onto the light wave for transmission through an optical fiber. More particularly, in some embodiments, the modulator can change the characteristics of a light beam, like its amplitude, phase, or polarization, based on an input electrical signal. For example, an amplitude modulator may include changing the intensity of the light. For example, a phase modulator, may include altering the phase of the light wave. For example, a polarization modulation may include modifying the polarization state of the light. In some embodiments, the modulator 301 may act like a switch for light, allowing for high-speed data transmission in fiber optic networks. In some embodiments, the modulator 301 utilizes an electro-optic effect, where an applied electric field changes the refractive index of a material, thereby affecting the light passing through it. lithium niobate may be used in electro-optic modulators due to their strong electro-optic properties. For optical modulators, in some embodiments, the composition of lithium niobate is pure lithium niobate (LiNbO₃), often referred to as “LN”, which exhibits excellent electro-optic properties due to the strong Pockels effect within the material. However, in some embodiments, depending on the desired application, sometimes lithium niobate can be doped with small amounts of magnesium oxide (MgO) to improve its resistance to photorefractive damage. Other dopants that may be used with lithium niobate can include iron (Fe), zinc (Zn), cerium (Ce), titanium (Ti), chromium (Cr), erbium (Er), hafnium (Hf), copper (Cu), gadolinium (Gd), manganese (Mn), and/or yttrium (Y).

In some embodiments, the lithium niobate modulator is a lithium niobate on insulator (LNOI) modulator. A lithium niobate on insulator (LNOI) modulator is a type of optical modulator that utilizes a thin film of lithium niobate deposited on an insulating substrate. In some embodiments, the insulator part refers to a layer of material like silicon dioxide beneath the lithium niobate film, which helps confine light within the waveguide and allows for precise patterning of optical circuits.

In some embodiments, forming a modulator 301 that is a lithium niobate on insulator (LNOI) modulator can begin with forming a lithium niobate containing layer on an insulating surface of an interposer substrate. In some embodiments, forming the lithium niobate containing layer on the insulating layer of the interposer substrate may include a layer transfer method. In some embodiments, the layer transfer method can include smart cut.

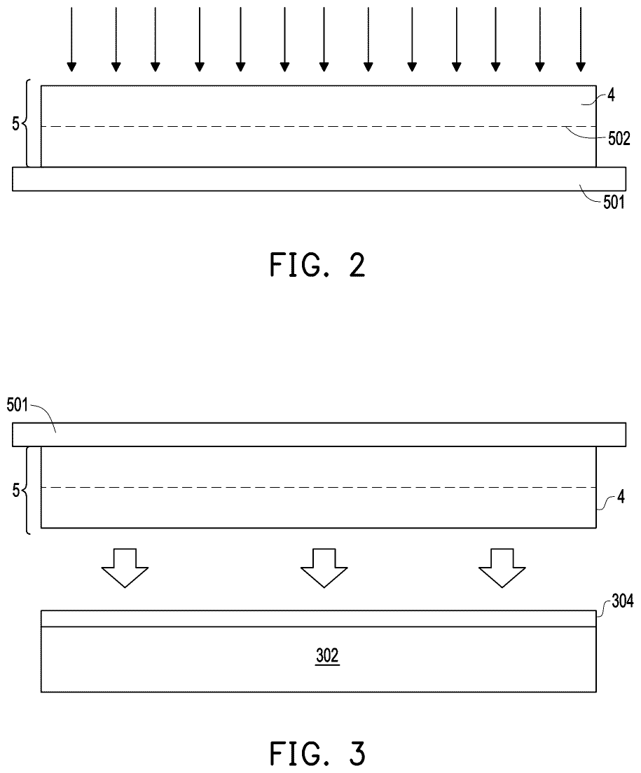

FIG. 2 illustrates one embodiment of forming a thin lithium niobate layer with the desired crystal orientation. In some embodiments, a donor substrate 5 of lithium niobate is first provided having an orientation that is to be cut in the X-cut orientation, which provides a good balance between efficient modulation and low frequency chip in the modulated signal. The donor substrate 5 may be engaged to a handling substrate 501. FIG. 2 further illustrates ion implantation to form to create a buried damage layer, also referred to as damage interface 502, within the donor substrate 5. In some embodiments, the ion implantation includes implanting ions, e.g., hydrogen and/or helium ions, into the donor substrate 5, creating a weakened region that provides the damage interface 502.

FIG. 3 illustrates an embodiment of bonding the donor substrate 5 to a modulator interposer 302, e.g., silicon (Si) (or organic, or glass) interposer. The upper surface of the modulator interposer 302, e.g., silicon (Si) (or organic, or glass) interposer, includes a dielectric surface layer 304, such as an oxide layer, e.g., silicon oxide (SiO₂) layer. The lithium niobate layer 4 of the donor substrate is bonded to the upper surface of the modulator interposer 302, in which the bonding surface of the modulator interposer 302 is provided by the dielectric surface layer 304. In some embodiments, bonding between the dielectric surface layer 304 and the lithium niobate layer 4 may be provided using fusion bonding (also referred to as direct bonding) and/or adhesive bonding.

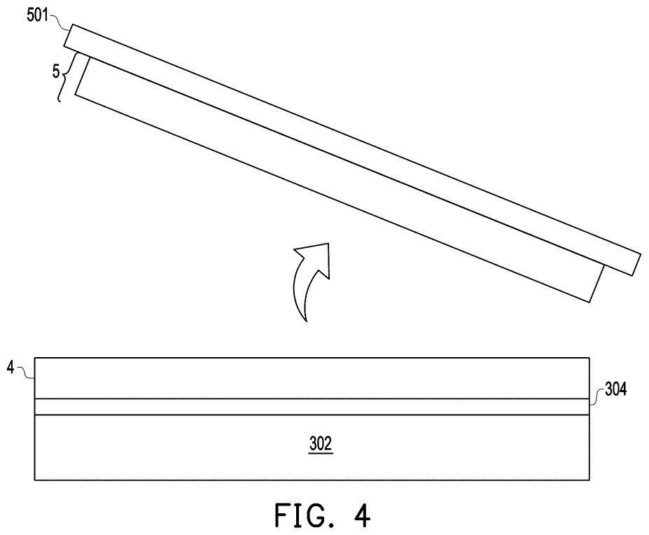

FIG. 4 illustrates an embodiment of separation (also referred to as cleaving) of the lithium niobate layer 4 from the donor substrate 5, in which the lithium niobate layer 4 is bonded to the dielectric surface layer 304 of the modulator interposer 302. In some embodiments, separation may occur upon an annealing steps that causes fracture along the damage interface 502. In some embodiments, during high-temperature annealing, the stress induced by the implanted layer, e.g., damaged cleavage interface, combined with the thermal expansion mismatch between the bonded wafers, e.g., the donor substrate 5 and the modulator interposer 302, causes the weakened layer to split apart.

It is noted that layer transfer and bonding the lithium niobate layer 4 to the modulator interposer 302 is only one example of how the lithium niobate layer 4 may be formed onto the dielectric surface layer 304. In other examples, the lithium niobate layer 4 may be formed using pulsed laser deposition (PLD) and/or metalorganic chemical vapor deposition (MOCVD).

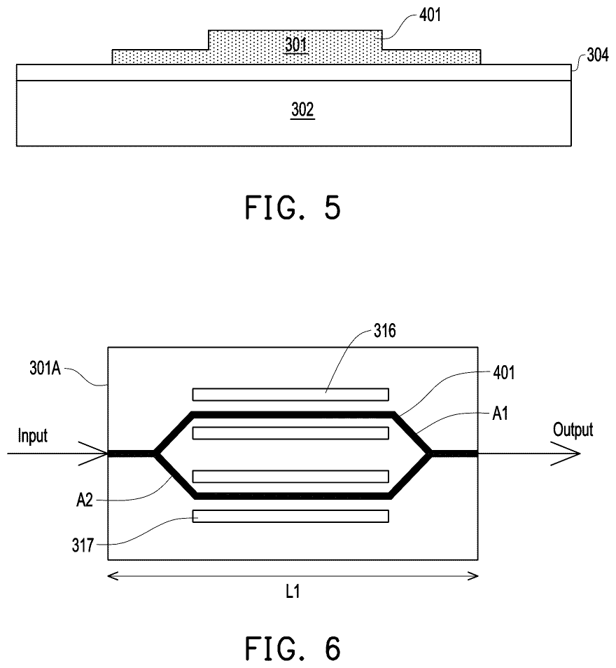

FIG. 5 illustrates photolithography and etching processes to form a modulator 301 from the lithium niobate layer 4. In some embodiments, the lithium niobate layer 4 may be patterned by applying a photoresist layer to the lithium niobate layer 4 and exposing it using UV light through a photomask to create the pattern for the modulator 301 (which may include a waveguide). In a following step, the patterned photoresist may be developed to reveal exposed areas for etching. In some embodiments, the etching process for forming the modulator 301 may include using a plasma or ion beam etching technique to define the modulator 301 in the lithium niobate layer 4.

The lithium niobate layer provides the lithium niobate material 401 for the modulator 301. For example, a damascene and/or planarization method may include depositing a thick layer of a planarizing material (e.g., a sacrificial oxide layer) to fill in the etched trenches used in shaping the geometry of the modulator 301, creating a smooth surface. In some embodiments, the planarization process may include performing chemical mechanical polishing (CMP) to planarize the surface.

In some embodiments, forming the modulator 301 may further include electrode formation. For example, a layer of metal may be deposited, e.g., a gold, silver, platinum and/or copper metal, may be formed using a deposition technique, e.g., a physical vapor deposition technique, such as sputtering. In some embodiments, the metal layer may be patterned and etching using a photolithography step followed by an etching step to create the electrodes that can apply a modulating voltage to the modulator 301. In another embodiment, lift off processes may be used in combination with or as an alternative too etching for shaping the geometry of the electrodes.

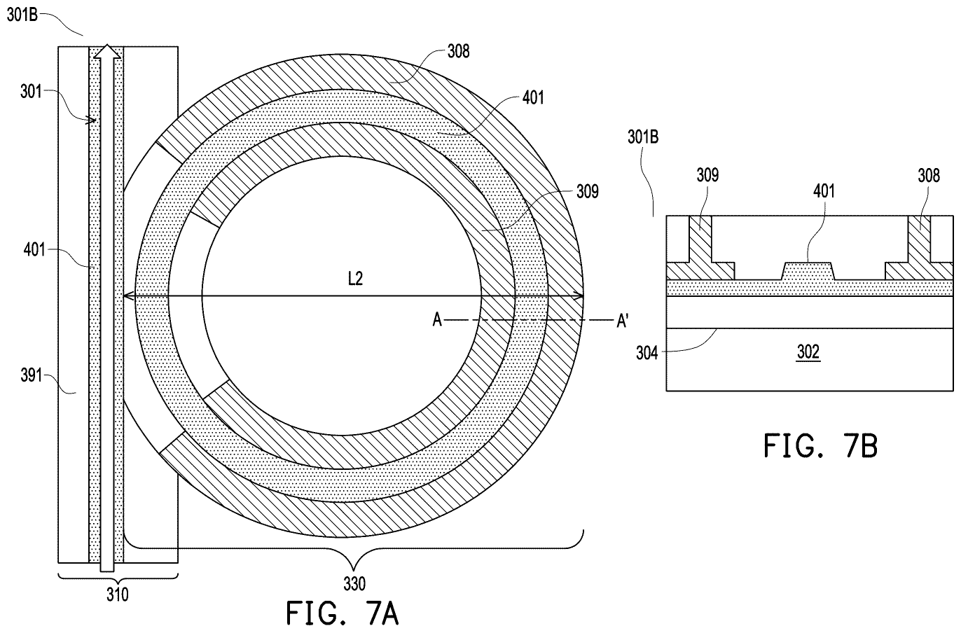

In some embodiments, the modulator 301 may be configured as a Mach-Zehnder modulator 301A, as illustrate in FIG. 6. A Mach-Zehnder modulator 301A is an optical device that uses the principles of a Mach-Zehnder interferometer to control the intensity of light by manipulating the phase difference between two split light beams into two arms A1, A2. In some embodiments, by achieved by applying an electrical voltage to one of the arms A1, A2, which alters its refractive index and thus the optical path length; modulation of the light signal is possible. More particularly, in some embodiments, the Mach-Zehnder interferometer splits light into two separate paths through the first and second arms A1, A2, which are then recombined. This can create interference patterns depending on the relative phase difference between the beams. The phase shift in the arms A1, A2 can be induced by applying a voltage to electrodes 316, 317 embedded in the waveguide, which alters the refractive index of the material due to the electro-optic effect. The length L1 of the Mach-Zehnder may range from 1 mm to 1 cm. However, in some examples, the length L1 of the Mach-Zehnder may be smaller, e.g., 200 microns to 300 microns. It is noted that in FIGS. 1-5 and 8-24B, the modulator 301 that is being depicted is a Mach-Zehnder modulator 301A, as illustrated in FIG. 6. However, it is not intended that the modulator 301 be limited to only this example. For example, in some embodiments, the modulator 301 may be configured in a ring modulator geometry, as illustrated in FIGS. 7A and 7B.

FIGS. 7A and 7B illustrate an embodiment of a ring resonator modulator 301B including a ring waveguide 330. Although the ring waveguide 330 of the ring resonator modulator 301B is depicted as being a circular ring, the methods and structures of the present disclosure are not limited to only this example. For example, the ring waveguide 330 may also be a rectangular ring, or a racetrack ring. To modulate the light, a material with electro-optic properties, e.g., lithium niobate material 401, is integrated within the ring waveguide 330, where changes in applied voltage cause a slight change in the refractive index, thereby shifting the resonant wavelength. In some embodiments, the resonant frequency is shifted by the applied electric field. The applied electric field is generated between the first and second electrode 308, 309 that are on opposing sides of the lithium niobate material 401 within the ring waveguide 330.

The ring resonator modulator 301B also includes an input/output waveguide bus 310. Light is coupled into and out of the ring waveguide 330 through the input/output waveguide bus 310, allowing for controlled transmission based on the resonant condition. The waveguide bus 310 can be made of the lithium niobate material 401, wherein the waveguide bus 310 further includes a cladding material 391. The cladding material 391 may be composed of a nitride, such as silicon nitride, polysilicon, and/or a polymeric material. It is noted that the cladding material 391 is not limited to only the aforementioned compositions. Other cladding compositions are equally applicable, so long as the composition is not equivalent to the lithium niobate material 401 of the ring resonator modulator 301B.

In some embodiments, by manipulating the resonant frequency of light within a closed loop waveguide, the ring waveguide 330 effectively acts as an optical filter where light at specific wavelengths is strongly transmitted when the resonance condition is met, allowing for modulation of the light signal by changing the refractive index of the ring, which can be achieved by applying an electrical signal to a built-in electro-optic material within the ring structure. Essentially, when the applied voltage shifts the resonance wavelength, the amount of light transmitted through the ring changes, thus achieving modulation. In some embodiments, light traveling within the ring waveguide 330 experiences constructive interference when the wavelength matches the circumference of the ring, which leads to a strong signal at the output, e.g., end of output for the waveguide bus 310. The length L2 of the ring resonator modulator 301B may range from 500 microns to 300 microns.

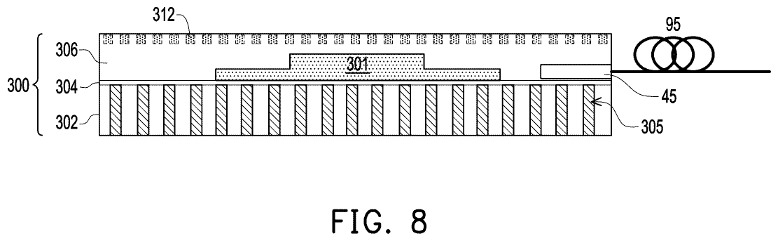

FIG. 8 illustrates further processing of the modulator module 300, which may include forming a dielectric layer/cladding layer 306 over the modulator 301. In some embodiments, the dielectric layer/cladding layer 306 may be an oxide, such as silicon oxide (SiO₂). However, other compositions are equally applicable for the dielectric layer/cladding layer 306 of the modulator module 300. For example, the dielectric layer/cladding layer 306 of the modulator module 300 may be silicon nitride, germanium oxide, germanium nitride, combinations of these including combinations with silicon oxide, or the like, formed using a deposition method such as chemical vapor deposition, atomic layer deposition, physical vapor deposition, spin on deposition or combinations of these, or the like.

FIG. 8 further illustrates that optical components may be formed over the modulator 301 within the dielectric layer/cladding layer. For example, depicted in FIG. 8 is a modulator edge coupler 45 that is connected to at an optical fiber 95. In some embodiments, the modulator edge coupler 45 can composed of silicon nitride (SiN), silicon oxynitride (SiON), polysilicon (poly-Si), polymeric materials and combinations thereof. The modulator edge coupler 45 may have a tapered shape, a polygonal shape, a rectangular shape, a round shape, an irregular shape, or another shape. In some embodiments, the optical fiber 95 can be for transmission of optical signals to/from the PIC die 250/modulator module 300. However, the optical components are not limited to just edge couplers, as depicted in FIG. 8. For example, the optical components in the dielectric layer/cladding layer 306 may include couplers, such as grating couplers, waveguides, modulators and other optical components. The dielectric/cladding layer may also include interconnect lines, e.g., metal lines for carrying electric signals to the different components within the modulator module 300. In some embodiments, the modulator module 300 further includes a number of contacts 312 formed atop the dielectric layer/cladding layer 306 that provides a contact surface for electrical communication with the interconnect lines within the dielectric layer/cladding layer 306.

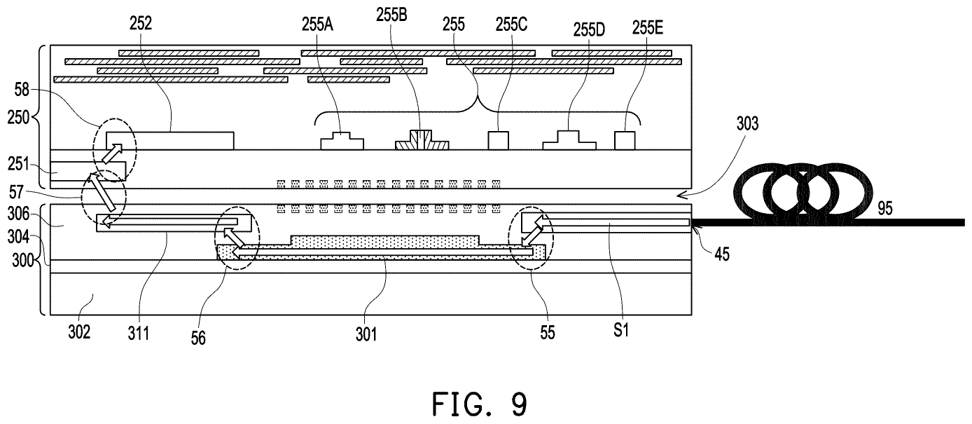

FIG. 8 further illustrates vias 305 vertically formed through the modulator interposer 302. The vias 305 may be through insulator vias (TIV) and/or through silicon vias (TSV). The vias 305 may be formed before or after the modulator 301 is formed. Further details regarding the PIC die 250 and the modulator module 300 are now described with detail to FIGS. 9 to 18.

FIG. 9 illustrates a modulator 301 interposed with a modulator interposer 302 in a modulator module 300, also referred to as interposed modulator (or interposed modulator module), that is bonded to the PIC die 250 of an optical module 150 and a corresponding light coupling scheme. In some embodiments, a continuous wave (CW) light is coupled to a modulator edge coupler 45 in the modulator module 300. FIG. 9 illustrates that an optical fiber 95 is connected to a modulator edge coupler 45. In some embodiments, a light signal S1 first enters the modulator module 300 through the modulator edge coupler 45, and then is transmitted from the modulator edge coupler 45 to the modulator 301 though a first optical via 55. The light signal S1 travels through the modulator 301, and exits the modulator through a second optical via 56 to an exit modulator waveguide 311. The continuous wavelength (CW) light is modulated by the modulator 301 to modulated light, and the modulated light is then coupled to the exit modulator waveguide 311, e.g., silicon nitride (SiN) waveguide, through the second optical via 56 in the interposer.

FIG. 9 illustrates that the modulated light from the exit modulator waveguide 311 then exits the modulator module 300. The modulated light exits the modulator module 300 and enters the PIC die 250 through a modulator to PIC optical via 57, where the modulated light signal is received by a PIC edge coupler 251, e.g., a backside silicon nitride (SiN) waveguide. The modulated signal is then coupled between the PIC edge coupler 251, e.g., silicon nitride coupler, of the PIC die 250 and a silicon waveguide 252. For example, the modulated light signal can be coupled between the PIC edge coupler 251 and the silicon waveguide 252 is through a Si/SiN waveguide optical via (waveguide optical via 58).

In some embodiments, the PIC die 250 performs most of the optical circuit operation after the modulated light is coupled to the silicon waveguide 252. The silicon waveguide 252 may be a component that is formed on the same level of as the optical components 255 within the PIC die 250. In some embodiments, both the silicon waveguide 252 and the optical components 255 may be silicon based. In some embodiments, the silicon optical components can include optical waveguides (e.g., ridge waveguides, rib waveguides, buried channel waveguides, diffused waveguides, etc.), couplers, directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. For example, in one embodiment, the optical components 255 can include a silicon-based rib waveguide 255A, a silicon-based modulator 255B, a 1^{st} silicon-based ridge waveguide 255C, a silicon based deep rib waveguide 255D, and a 2^{nd} silicon-based ridge waveguide 255E. It is noted that the optical components depicted in FIG. 9 is only one example of the present disclosure, and it is not intended that the present disclosure be limited to only this example.

In some embodiments, the modulator edge coupler 45 is located at an edge of the modulator module 300. In some embodiments, the optical fiber 95 may be secured to the modulator edge coupler 45 using optical glue. In some embodiments, a fiber trench may be further employed to facilitate the engagement of support the optical fiber 95 and facilitate alignment of the optical fiber 95 with the modulator edge coupler 45. The fiber trench may be formed in the cladding adjacent to the modulator edge coupler 45 by photolithography and etching techniques.

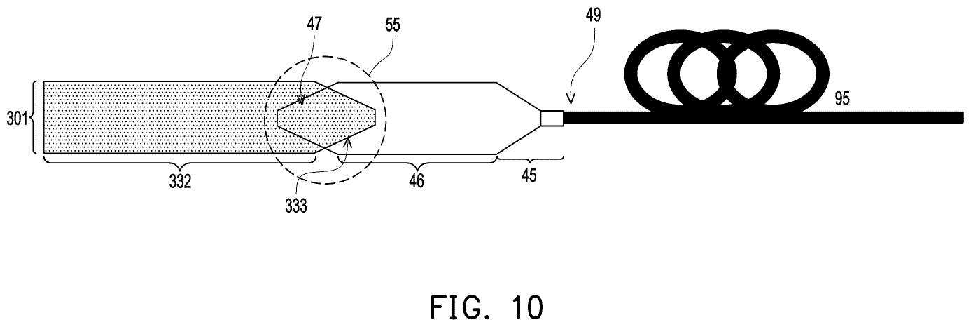

In some embodiments, the modulator edge coupler 45 may be made of silicon nitride (“SiN”), polysilicon, polymer, or other materials alike. The modulator edge coupler 45 includes a narrow portion for interfacing with the optical fiber 95 for receiving the light signal S1, and the modulator edge coupler 45 further includes a wider wave guide (WG) portion 46 that carriers the light signal S1 towards other components in the modulator module 300. In some embodiments, the waveguide portion 46 is opposite the end of the modulator edge coupler 45 that is connected to the optical fiber 95, as illustrated in FIG. 10.

In some embodiments, different optical applications may use different fiber types (for the optical fiber 95) with different mode field diameters (MFDs), e.g., varying from 2 to 30 micrometers. In some embodiments, the modulator edge coupler 45 may each be composed of silicon nitride. In some embodiments, the modulator edge coupler 45 is a spot size edge coupler. A spot size edge coupler is a type of optical device used to couple light from a fiber optic cable to a waveguide, e.g., waveguide portion 46 of the modulator edge coupler 45, by utilizing a spot size converter (SSC) at the edge of the chip to match the different mode sizes of the fiber and the waveguide, allowing for efficient light transfer between the two mediums. In some embodiments, the spot size converter acts as a bridge to smoothly transition the light from the larger fiber mode to the smaller waveguide mode at the edge of the chip.

In the embodiment depicted in FIGS. 9 and 10, before forming the modulator edge coupler 45, a dielectric layer can be deposited over the modulator 301. The dielectric layer may be silicon oxide, silicon nitride, germanium oxide, germanium nitride, combinations of these, or the like, formed using a deposition method such as chemical vapor deposition, atomic layer deposition, physical vapor deposition, combinations of these, or the like. The thickness of the dielectric layer can dictate the dimension vertically separating the waveguide portion 46 of the modulator edge coupler 45 from the waveguide portion 332 of the modulator 301.

The material layer for the modulator edge coupler 45 may then be formed. In some embodiments, the modulator edge coupler 45 can composed of silicon nitride (SiN), silicon oxynitride (SiON), polysilicon (poly-Si), polymeric materials and combinations thereof. In some embodiments, in which the modulator edge coupler 45 is composed of silicon nitride, the modulator edge coupler 45 may be formed by depositing a layer of silicon nitride (not shown) and then patterning the silicon nitride layer using photolithography and etching techniques. For example, a silicon nitride layer may be blanket deposited using a deposition technique, such as CVD, LPCVD, PVD, or the like. The etching process may include a dry etching process and/or a wet etching process. The modulator edge coupler 45 may have a tapered shape, a polygonal shape, a rectangular shape, a round shape, an irregular shape, or another shape. In some embodiments, cladding may be formed surrounding the modulator edge coupler 45. By forming the cladding such that the modulator edge coupler 45 is covered by the cladding and laterally isolated by air, the loss of optical signal may be reduced. The cladding may be formed by forming an oxide layer over the modulator edge coupler 45.

FIG. 10 illustrates one embodiment of the modulator edge coupler 45 leading into a waveguide portion 46 of the modulate edge coupler 45 that is overlying a waveguide portion 332 of the modulator 301. In some embodiments, the light is first coupled to the modulator module 300 through the modulator edge coupler 45. The light then travels along a reverse taper to a wider waveguide portion 46 of the modulator edge coupler 45. A tapered end portion 47 of the modulator edge coupler 45 overlaps a reverse taper portion 333 of a waveguide portion 332 of the modulator 301. The overlap between the tapered end portion 47 of the modulator edge coupler 45 and the reverse taper portion 333 for the waveguide portion 332 of the modulator 301 provides a first optical via 55.

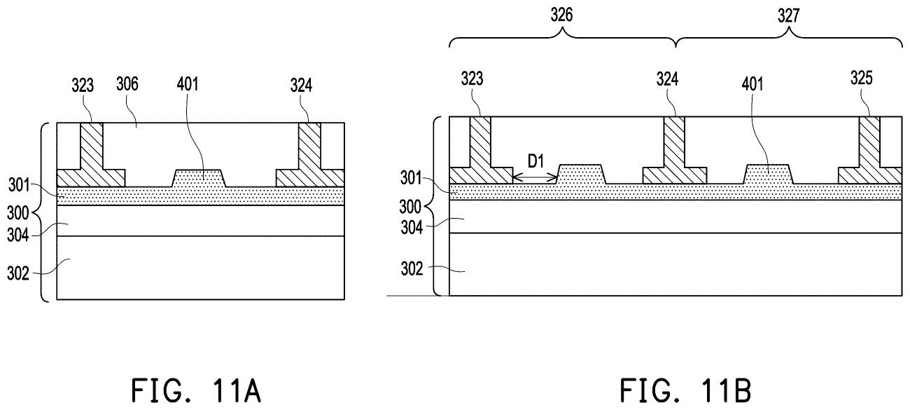

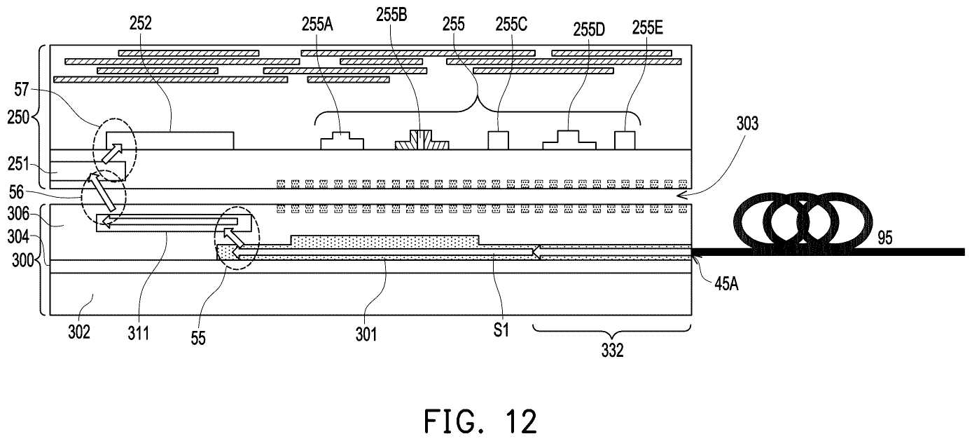

FIGS. 11A and 11B illustrate some embodiments for cross-sections of the modulator 301. More particularly, FIG. 11 A is a cross section of a phase shifter portion of the modulator 301, in which the phase shifter components is between two phase shifter electrodes, e.g., a first phase shifter electrode 323 and a second phase shifter electrode 324. FIG. 11B is a cross section of a modulator 301, in which the modulator includes two phase shifter components, e.g., a first phase shifter component 326 and a second phase shifter component 327. For example, a first phase shifter component 326 is between a first set of phase shifter electrodes 323, 324 and a second phase shifter component 327 is between a second set of phase shifter electrodes 324, 325. The metal electrodes, e.g., first set of phase shifter electrodes 323, 324 and second set of phase shifter electrodes 324, 325, and lithium niobate material 401 of the modulator 301 may be separated by a gap ranging from approximately 20 nm to approximately 150 nm for minimizing optical loss. In some embodiments, the horizontal distance D1 between the metal electrodes, e.g., first set of phase shifter electrodes 323, 324 and second set of phase shifter electrodes 324, 325, and the rib of the lithium niobate material 401 of the modulator 301 may range from approximately 500 nm to approximately 1000 nm to trade off modulation efficiency and optical loss. It is noted that the cross-sections for the modulator 301 depicted in FIGS. 11A and 11B are applicable to the modulator 301 that is depicted in each of the following embodiments that are described with reference to FIGS. 12-18.

FIG. 12 shows another embodiment of the modulator module 300, PIC die 250, and light coupling scheme. The embodiment that is illustrated in FIG. 12 is similar to the embodiment that is illustrated in FIG. 9. Therefore, elements having the same reference numbers in FIGS. 9 and 12 may share the same description. However, in FIG. 12, a continuous wave (CW) light source is connected to an optical fiber 95 that is coupled to an edge coupler 332B that is a component of the modulator 301. More particularly, the edge coupler 332B and the modulator 301 are both composed of lithium niobate. In the embodiment depicted in FIG. 12, the modulator edge coupler 45 (as depicted in FIG. 9) that is physically separated from the modulator 301 is omitted. In the embodiment depicted in FIG. 12, the optical fiber 95 is still coupled to the modulator module 300, however the optical fiber 95 is coupled directly to the modulator 301 through the modulator edge coupler 45A. Similar to the embodiment depicted in FIG. 9, following modulation of the light by the modulator 301, the modulated light is coupled to the PIC edge coupler 251, e.g., a backside silicon nitride (SiN) waveguide, and then the silicon waveguide 252 of the PIC die 250, through the second optical via 56 in the modulator module 300 and the modulator to PIC optical via 57.

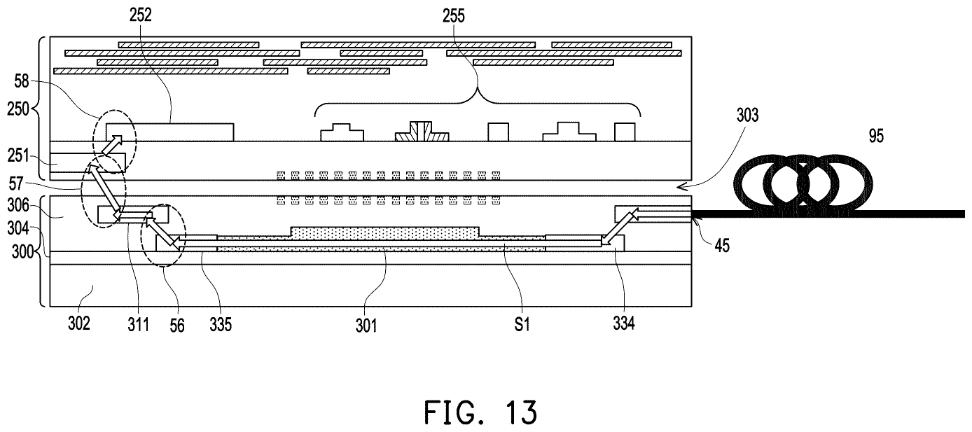

FIG. 13 depicts another embodiment of the modulator module 300, PIC die 250, and light coupling scheme. The embodiment that is illustrated in FIG. 13 is similar to the embodiment that is illustrated in FIG. 9. Therefore, elements having the same reference numbers in FIGS. 9 and 12 may share the same description. However, in FIG. 13, there are waveguides, e.g., modulator input waveguide 334 and modulator output waveguide 335, for the light signal S1 going into and out of the modulator 301 that are on the same level as the modulator 301. This is an element that is depicted in the embodiment that is illustrated in FIG. 13 that is distinguishable from the embodiments illustrated in FIG. 9. Further, the modulator input waveguide 334 and modulator output waveguide 335 are composed of a different material than the modulator 301. For example, while the modulator 301 is composed of lithium niobate, the modulator input waveguide 334 and modulator output waveguide 335 may be composed of silicon nitride. Similar to the embodiment depicted in FIG. 9, following modulator of the light by the modulator 301, the modulated light is coupled to the PIC edge coupler 251, e.g., a backside silicon nitride (SiN) waveguide, and then the silicon waveguide 252 of the PIC die 250, through the second optical via 56 in the modulator module 300 and the modulator to PIC optical via 57.

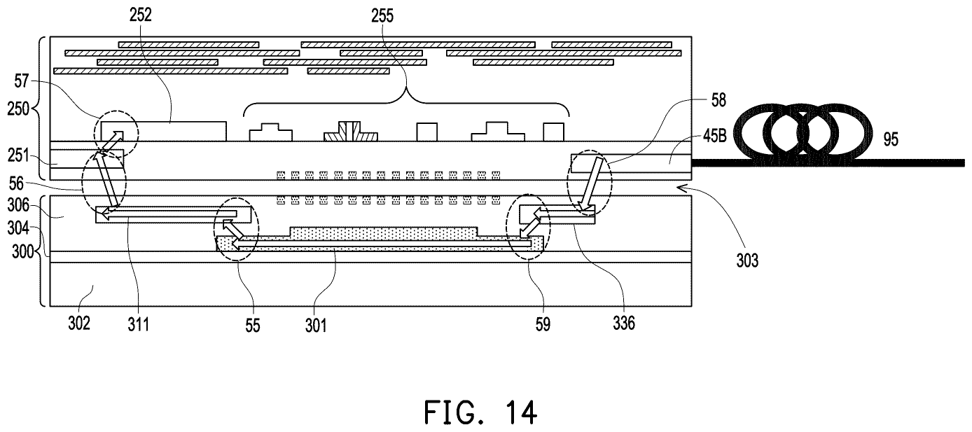

FIG. 14 depicts yet another embodiment in which the PIC die 250 includes a backside PIC edge coupler 45B that is coupled to the optical fiber 95 that is carrying the continuous wave (CW) signal into the device. The embodiment that is illustrated in FIG. 14 is similar to the embodiment that is illustrated in FIG. 9. Therefore, elements having the same reference numbers in FIGS. 9 and 14 may share the same description. However, in FIG. 14 the light is first entering the device through the PIC die 250. More particularly, the light from the optical fiber 95 enters the PIC die 250 through the backside PIC edge coupler 45B. The modulator edge coupler 45 that is illustrated in FIG. 9 is omitted from the embodiment depicted in FIG. 14. The modulator module 300 further includes an input modulator waveguide 336. The input modulator waveguide 336 is coupled with the backside PIC edge coupler 45B through a PIC edge coupler to waveguide optical via 58 for transmission of the light signal S1 between the PIC die 250 and the modulator module 300. The light travels from the input modulator waveguide 336 to the modulator 301 through a waveguide to module optical via 59. In the embodiment depicted in FIG. 9, the input modulator waveguide 336 and the backside PIC edge coupler 45B may be composed of silicon nitride. However, the input modulator waveguide 336 and the backside PIC edge coupler 45B may also be composed of silicon or polymeric materials. Similar to the embodiment depicted in FIG. 9, following modulator of the light by the modulator 301, the modulated light is coupled to the PIC edge coupler 251, e.g., a backside silicon nitride (SiN) waveguide, and then the silicon waveguide 252 of the PIC die 250, through the second optical via 56 in the modulator module 300 and the modulator to PIC optical via 57.

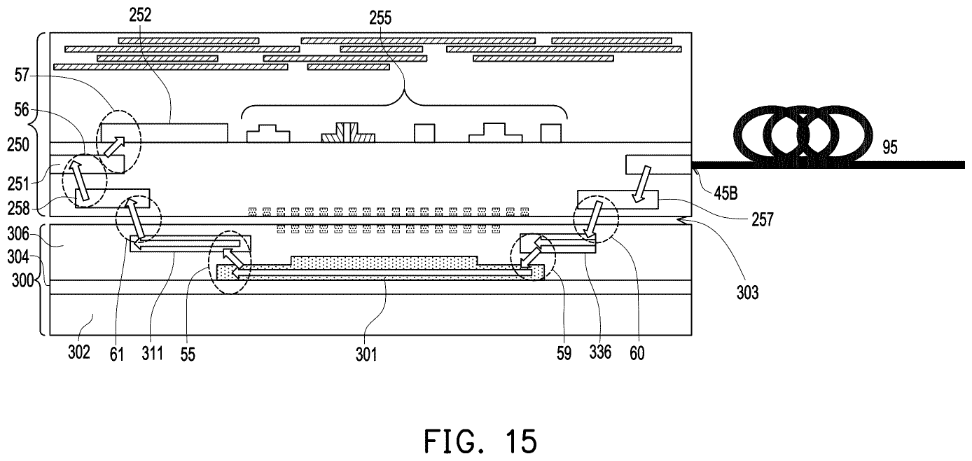

FIG. 15 depicts yet another embodiment of a modulator module 300, a PIC die 250, and light coupling scheme. The embodiment that is illustrated in FIG. 15 is similar to the embodiment that is illustrated in FIG. 14. For example, the embodiments depicted in FIGS. 14 and 15 both include a backside PIC edge coupler 45B. Therefore, elements having the same reference numbers in FIGS. 14 and 15 may share the same description. However, the embodiment depicted in FIG. 15 further includes as waveguide that is integrated into the backside of the PIC die 250, which is hereafter referred to as a first backside PIC waveguide 257. The first backside PIC waveguide 257 is positioned between the backside PIC edge coupler 45B within the backside of the PIC die 250 and the input modulator waveguide 336 to the modulator 301. The input modulator waveguide 336 is coupled with the first backside PIC waveguide 257 through a PIC waveguide to waveguide optical via 60 for transmission of the light signal S1 between the PIC die 250 and the modulator module 300. The light travels from the input modulator waveguide 336 to the modulator 301 through a waveguide to module optical via 59. In the embodiment depicted in FIG. 9, the input modulator waveguide 336 and the backside PIC edge coupler 256 may be composed of silicon nitride. However, the input modulator waveguide 336 and the backside PIC edge coupler 256 may also be composed of silicon or polymeric materials.

FIG. 15 further illustrates that the backside of the PIC die 250 also includes a second backside PIC waveguide 258 for coupling the light signal S1 from the modulator module 300 to the PIC die 250 through an optical via 61. The optical via 61 receives the light signal from the exit modulator waveguide 311 and transmits the light signal S1 to the second backside PIC waveguide 258 of the PIC die 250. In some embodiments, the second backside PIC waveguide 258 is composed of silicon nitride. In some embodiments, the second backside PIC waveguide 258 may also be composed of a silicon-based material, such as polysilicon and/or a polymeric material. The second backside PIC waveguide 258 is on a same level as the first backside PIC waveguide 257 and therefore may be processed from the same material layer during manufacturing. Similar to the embodiment depicted in FIG. 14, following receipt of the signal at the second backside PIC waveguide 258, the modulated light is coupled to the PIC edge coupler 251, e.g., a backside silicon nitride (SiN) waveguide, through the second optical via 56, and then the silicon waveguide 252 of the PIC die 250 through the PIC optical via 57.

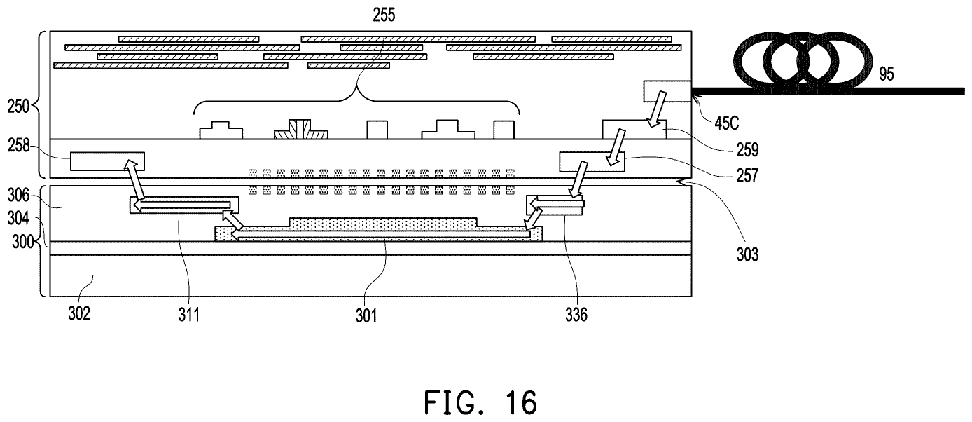

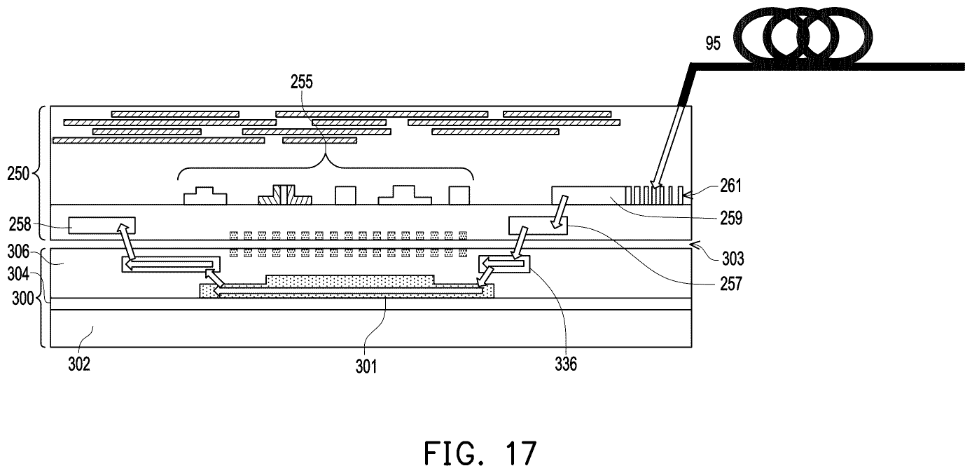

FIG. 16 depicts yet another embodiment of a modulator module 300, a PIC die 250, and light coupling scheme. The embodiment that is illustrated in FIG. 16 is similar to the embodiment that is illustrated in FIGS. 14 and 15, in which light from the optical fiber 95 is first coupled to transmit the light signal to the PIC die 250 before the signal is transmitted through the PIC die 250 during transmission to the modulator module 300. However, in the embodiments depicted in FIGS. 14 and 15, the coupling of the optical fiber 95 to the PIC die 250 is via a backside connection, i.e., beneath the optical components 250. In the embodiment that is depicted in FIG. 16, the optical fiber 95 is coupled to the PIC die 250 by a frontside connection. More particularly, for the embodiment depicted in FIG. 16, a front side edge coupler 45C receives the light signal S1 from the optical fiber 95 and transmits by an optical via to a front side waveguide 259. The front side edge coupler 45C may be composed of a nitride containing material, such as silicon nitride. In other embodiments, the front side edge coupler 260 may also be composed of a silicon or may be composed of a polymeric material. The front side waveguide 259 may be composed of silicon, and may be formed on the same level as the optical components 255. The front side waveguide 259 and the optical components 255 may be formed from the same material layer. Following light coupling to the front side waveguide 259, the light signal path may be the same as depicted in FIG. 15.

FIG. 17 illustrates yet another embodiment of a modulator module 300, a PIC die 250, and light coupling scheme. The embodiment depicted in FIG. 17 is similar to the embodiment depicted in FIG. 16. Similar to FIG. 16, in the embodiment that is depicted in FIG. 17, the light from the optical fiber 95 is first coupled to transmit the light signal to the PIC die 250 using a front side coupler. However, the coupler used in the embodiment depicted in FIG. 16 is an edge coupler, e.g., the front side edge coupler 45C, whereas the front side coupler that is used in the embodiment illustrated in FIG. 17 is a grated coupler 261. An “edge coupler” directly couples light into a waveguide by aligning the fiber to the chip's edge, while a “graded coupler” refers to an edge coupler that utilizes a graded-index lens to improve the coupling efficiency by smoothly transitioning the light between the fiber and the waveguide.

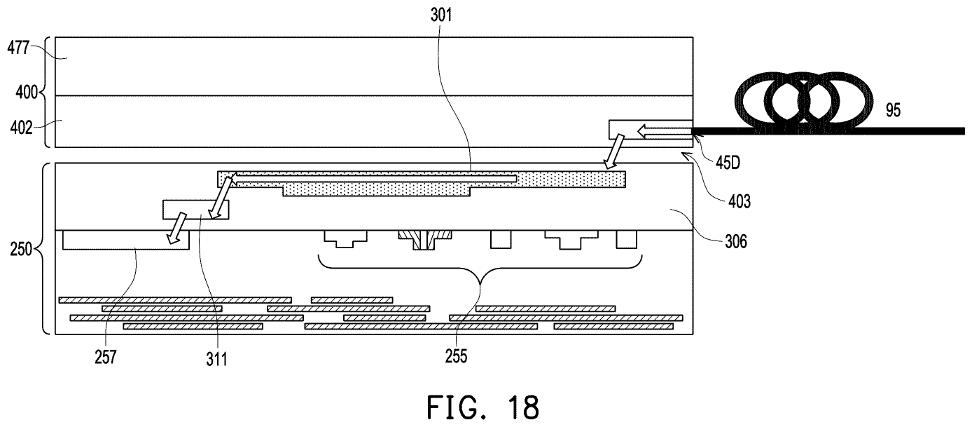

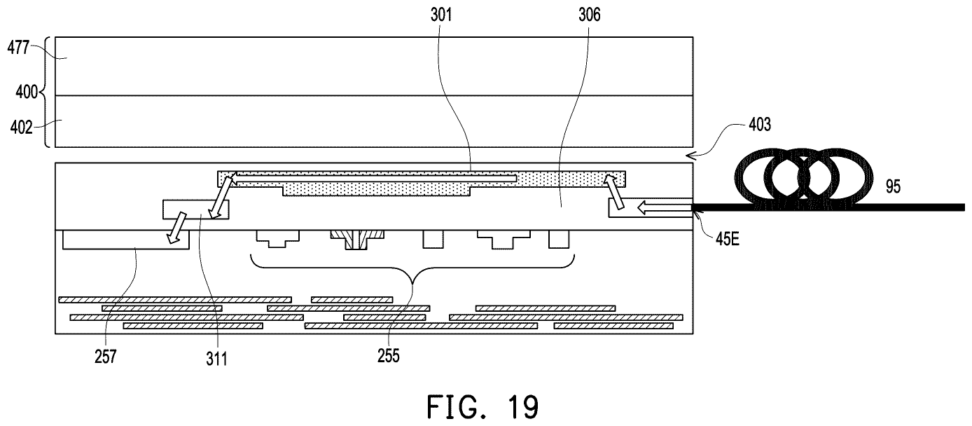

FIGS. 18 and 19 illustrate embodiments, in which the modulator 301 is formed on the backside of the optical components 255 in the PIC die 250. In this embodiment, the edge coupler is integrated into a supporting interposer die 400. In this embodiment, the optical components 255 of the PIC die 250 are formed from a silicon layer that was formed on a supporting substrate. Following processing of the optical components 255, one or more dielectric layers, metal interconnect wires may be formed overlying the optical components 255. The optical components 255 may be formed from a silicon containing material layer using photolithography and etch processes. In some embodiments, an exit modulator waveguide 311 may also be formed from the silicon containing material layer that is used to provide the optical components. Metal interconnect lines may be formed in the dielectric layer that is overlying the optical components 255 and the exit modulator waveguide 311.

In FIG. 18, the PIC die 250 is depicted as being flipped over. The supporting substrate of the PIC die 250 can then be removed to exposed the backside of the optical components 255. The supporting substrate may be removed using grinding, such as chemical mechanical planarization, and/or etching. However, the supporting substrate can also be removed by smart cut. In the embodiment depicted in FIG. 18, the modulator 301 may then be bonded on the backside surface of the PIC die 250 including the backside of the optical components 255. Forming the modulator 301 has been described above with reference to FIGS. 2-8. Bonding of the modulator 301 to the backside of the PIC die 250 may be through the dielectric layer/cladding layer 306 that is formed over the modulator 301. For example, bonding of the dielectric layer/cladding layer 306 to the backside of the PIC die 250 may be through an adhesive bond. In some embodiments, an exit modulator waveguide 311 may be formed in the dielectric layer/cladding layer 306. The exit modulator waveguide 311 may be composed of a nitride containing material, such as silicon nitride.

In the embodiment depicted in FIG. 18, an interposer edge coupler 45D may be integrated into a supporting interposer die 400. The supporting interposer die 400 may include an interposer substrate 477 that may be composed of a rigid material. For example, the interposer substrate 477 may be composed of silicon, glass and/or a rigid polymeric (organic) material. The interposer edge coupler 45D may be composed of a silicon nitride material and may be integrated into a backside facing dielectric layer 402 that is present on the interposer substrate 477. The backside facing dielectric layer 402 may be composed of silicon oxide.

FIG. 18 illustrates that the PIC die 250 is then coupled to a Si (or organic, glass) interposer by a PIC to interposer substrate module bonds 403 through covalent fusion bonding and/or hybrid-bonding. The continuous wave (CW) light is coupled to the interposed edge coupler 45D in the supporting interposer die 400, which is then transmitted to the modulator 301 in the backside of the PIC die 250. In some embodiments, instead of the interposer edge coupler 45D being positioned in the supporting interposer die 400, a backside edge coupler 45E may be positioned in the dielectric layer/cladding layer 306 that is positioned between the modulator 301 and the optical components 255. It is noted that FIGS. 18 and 19 share elements with the previously described embodiments that are illustrated in FIGS. 1-17. Therefore, elements having reference numbers depicted in FIGS. 18 and 19 my share a description for those same reference numbers depicted in FIGS. 1-17.

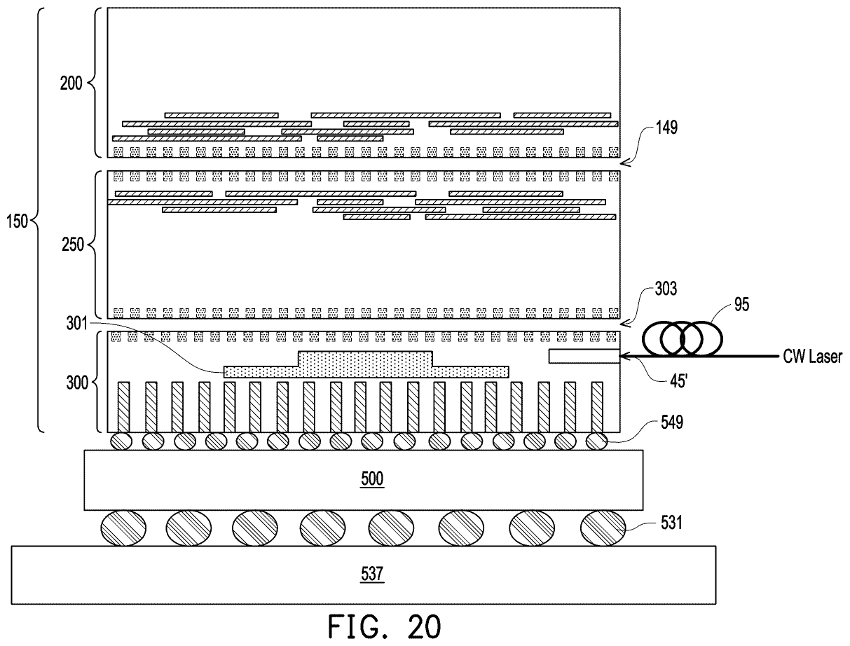

FIG. 20 illustrates an embodiment of an optical module 150 that is packaged in a three-dimensional (3D) electro optical package. For example, the three-dimensional (3D) electro optical package that is depicted in FIG. 20 may be a three dimensional (3D) heterogeneously integrated optical transceiver. In some embodiments, the three-dimensional electro optical package may include an EIC die 200, a PIC die 250 and a modulator module 300 including a modulator 301 (e.g., interposed modulator). In some embodiments, the EIC die 200, the PIC die 250 and the modulator module 300 are vertically stacked to form an EO (Electrical-Optical) module or Optical Engine (OE). In some embodiments, the EIC die 200, the PIC die 250 and the modulator module 300 are bonded to each other in an optical module 150. Some embodiments of the optical module 150 have been described above with reference to FIG. 1. It is noted that the optical module 150 that is illustrated in FIG. 1 only represents one embodiment of the present disclosure, and it is not intended that the methods and structures described herein be limited to only the embodiment that is depicted in FIG. 1. For example, the different embodiments of the PIC die 250 and the modulator module 300 that are described above with reference to FIGS. 9-19 may be substituted for the modulator module 300 and the PIC die 250 within the optical module 150 depicted in FIG. 1. It is noted that the edge coupler identified by reference number 45′ in FIG. 20 may be provided by any of the edge couplers having reference numbers 45A, 45B, 45C, 45D and 45E. The edge coupler 45′ may also be substituted with a grated coupler 261.

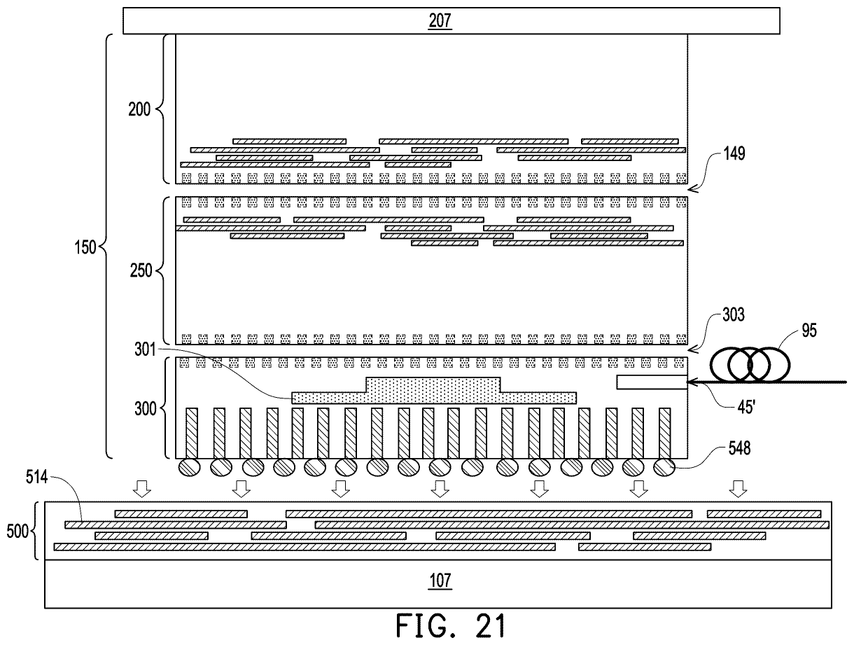

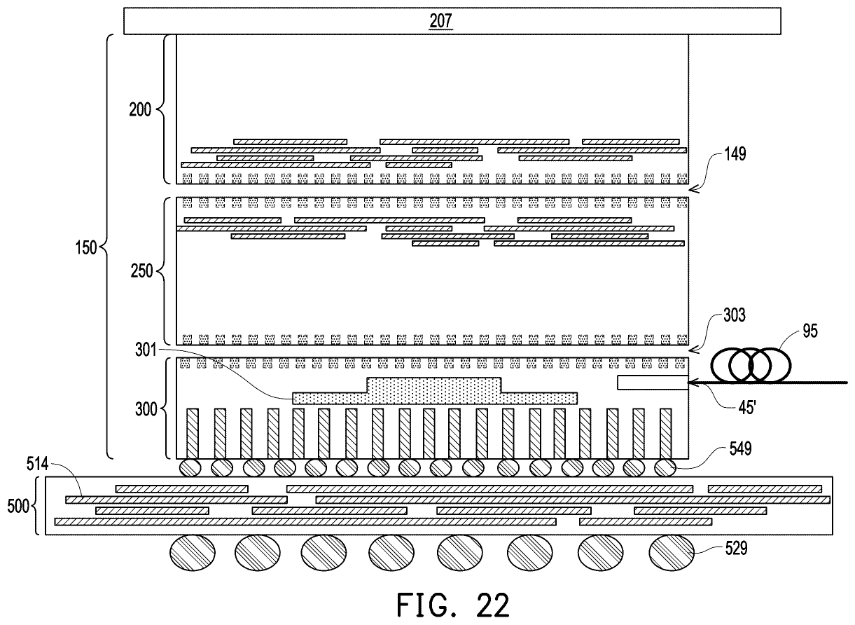

FIG. 20 illustrates that the optical module 150 is coupled to a redistribution layer (RDL) substrate 500 through C4 bumps and then coupled to a Printed Circuit Board (PCB) through Ball Grid Array (BGA), Pin Grid Array (PGA), or Land Grid Array (LGA). The method of bonding the optical module 150 to the redistribution layer (RDL) substrate 500, and the method of bonding the assembly of the optical module 150 and the redistribution layer (RDL) substrate 500 to the packaging substrate 537 are now described with reference to FIGS. 21 and 22.

FIG. 21 illustrates one embodiment of the redistribution layer (RDL) substrate 500 being formed on a first carrier substrate 107. The redistribution layer (RDL) substrate 500 includes one or more metal interconnect lines 514 that electrically connect subsequently bonded devices, such as the optical module 150, to a subsequently bonded package substrate 137 for signal and/or power routing. The redistribution layer (RDL) substrate 500 includes one or more metal interconnect lines 514 in electrical communication with bonding pads to connect to solder balls.

The metal interconnect lines 514 may be formed in one or more layers of insulating material. In some embodiments, the one or more layers of insulating material in the redistribution layer (RDL) substrate 500 may have an organic composition. For example, the insulating material in the redistribution layer (RDL) substrate 500 may be a polymeric composition. In some examples, the insulating material in the redistribution layer (RDL) substrate 500 may be a polymer material, such as an epoxy. For example, the insulating material of the redistribution layer (RDL) substrate 500 may be an epoxy resin providing the matrix for a composite material, the composite material further including an amine-based compound harder, filler materials including silica and/or alumina, flexabilizers, and/or curing agents. In other embodiments, the insulating material of the redistribution layer (RDL) substrate 500 may be a silicon containing inorganic material. In some embodiments, the insulating material in the redistribution layer (RDL) substrate 500 may have a dielectric constant of less than 3.5. For example, the insulating material in the redistribution layer (RDL) substrate 500 may have a dielectric constant of about 3.3.

The redistribution layer (RDL) substrate 500 may be formed using deposition processes, spin on processes, or the like forming the insulating materials, e.g., polymeric insulating materials. Openings and trenches for metal lines and/or traces may be formed using photolithography and etch processes. Further, a metal material, such as copper and/or aluminum, for the metal lines and/or traces may be formed using deposition processes, such as sputtering, plating processes, or the like. In some embodiments, the upper surface of the redistribution layer (RDL) substrate 500 (e.g., an upper layer of insulating material) may be planarized using a planarization process, such as chemical mechanical planarization (CMP).

In some embodiments, the redistribution layer (RDL) substrate 500 may be formed on a first carrier substrate 107 through a bonding layer. The first carrier substrate 107 may be formed of any rigid material, e.g., metal, glass and/or semiconductor material (e.g., silicon (Si). In some embodiments, the bonding layer may be a release film, which may be a Light-to-Heat Conversion (LTHC) layer.

FIGS. 20 and 21 illustrate the optical module 150 being bonded to the upper surface of the redistribution layer (RDL) substrate 500. In some embodiments, the optical module 150 may be bonded to the redistribution layer (RDL) substrate 500, for example, through die solder bonds 549, as depicted in FIG. 20. In an example, the die solder bonds 549 may be provided by controlled collapse chip connection (C4) bumps. Although the bonding of the optical module 150 to the redistribution layer (RDL) substrate 500 is described using solder bonds, in some other embodiments, bonding may be provided using microbumps, direct bonding (copper-to-copper bonding) and/or hybrid bonding.

FIGS. 21 and 22 illustrate the optical module 150 to the redistribution layer (RDL) substrate 500 using a solder bonding/flip chip type process. The die solder bonds 549 provide for connection between the contacts pads of the one or more metal interconnect lines 114 and the contact pads of the optical module 150. In an example, C4 solder bonds provides the die solder bonds 549 connecting the optical module 150 to the redistribution layer (RDL) substrate 500, in which the solder bonds may have a bump size, e.g., diameter, of approximately 100 microns or greater. In some embodiments, the die solder bonds 549 may also be formed of lead-free materials, such as SnAg, SnCu, SnAgCu. In some other cases, the die solder bonds 549 may be formed of PbAg. In some embodiments, the die solder bonds 549 may be formed using indirect bonding, mass reflow, thermal compression bonding, direct bonding, insert bump bonding and combinations thereof. It is noted that the above methods are provided for illustrative purposes only. Other examples of solder application methods include printing of solder paste, engraved mask stump, photosensitive organic mask and squeegee, electroplating of solder, evaporation, needle dispensing, solder paste printing, plated solder bumps, plated copper pillars with micro-bumps and combinations thereof.

Referring to FIG. 22, after the application of solder 548 (depicted in FIG. 21) to the contacts for the logic component, the solder 548 may then be contacted to the contacts on the contact pads of the one or more metal interconnect lines 514 of the RDL substrate 500 under elevated temperature and pressure to effectuate bonding, e.g., forming die solder bonds 149. Following bonding, an underfill (not shown) may be applied. The underfill may be a thermoset epoxy or polymer that's applied to the die solder bonds 549 to protect them and strengthen solder joints. In some embodiments, the underfill may be applied after the solder bumps have gone through a reflow oven and may be dispensed using an automated syringe. The underfill may then be applied, in which the underfill flows underneath the optical module 150 using capillary action. In some embodiments, after application, the underfill is cured by being heated.

Following the formation of the underfill, the structure may be encapsulated in an encapsulant (not shown), e.g., by over molding. For example, the structure including the optical module 150 bonded to the redistribution layer (RDL) substrate 500, may be positioned within a mold, and a molding material may be injected into the mold to encapsulate the integrated circuit devices 120 to the redistribution layer (RDL) substrate 500. The molding material for the encapsulant may be an epoxy material. Following hardening of the encapsulant, the hardened structure may be planarized. For example, the encapsulant may be planarized using chemical mechanical planarization to expose upper surfaces of the optical module 150.

FIG. 21 illustrates the upper surface of the optical module being attached to a transfer substrate 207, e.g., tape structure. In some embodiments, the tape structure that provides the transfer substrate 207 may be an ultraviolet tape, although any other suitable adhesive or attachment may be used. In some embodiments, after the transfer substrate 207 is attached to the optical module 150, the first carrier substrate 107 may be removed. For example, the first carrier substrate 107 may be debonded, for example, by projecting a laser beam on the release film, thus decomposing the release film. After removing the first carrier substrate 107, the back-side surface of the redistribution layer (RDL) substrate 500 is exposed.

FIG. 22 illustrates one embodiment of a solder bond process applied to the redistribution layer (RDL) substrate 500. In some embodiments, solder bumps 529 are formed on contacts to the one or more metal interconnect lines 514 of the redistribution layer (RDL) substrate 500. In some embodiments, the solder bumps 529 may be controlled collapse chip connection (C4) bumps. The solder bumps 529 may be used to bond the redistribution layer (RDL) substrate 500 to a package substrate 537 to provide the final packaged structure that is depicted in FIG. 20. The term “solder”, as used herein, refers to any metal or metallic compound or alloy that is melted and then allowed to cool in order to join two or more metallic surfaces together. For example, solders have melting temperatures in the range of 150 °C to 250 °C. Solder bumps may be small spheres of solder (solder balls) that are bonded to contact areas, interconnect lines or pads of semiconductor devices. In some embodiments, the solder bumps may be made from lead-free solder mixtures or lead tin solder.

In some embodiments, the solder bump process for forming the package solder bonds 531 (as depicted in FIG. 20) may include an in-situ sputter clean to remove oxides or photoresist prior to metal deposition on the contacts to the one or more metal interconnect lines 514. The cleaning may also serve to roughen the surface of the contacts (also referred to as bond pads) in order to promote better adhesion of the under-ball metallization (UBM). A metal mask having an array pattern may be used to pattern the structure for UBM and bump deposition. In some embodiments, a sequential evaporation of a chromium layer, a phased chromium/copper layer, a copper layer and a gold layer are deposited to form a thin film under ball metallurgy (UBM) on the contacts to the one or more metal interconnect lines 514. In one example, lead-tin solder is then evaporated on top of the UBMs to form thick layers of solder. The height of the resulting solder bumps are determined by the volume of the evaporated material that is deposited. This is also a function of the distance between the metal mask and the wafer, as well as the sizes of the mask openings. The deposited solder may be conical in shape, due to the way that the solder is formed in the openings of the solder mask. The solder may be reflowed to form spheres.

The assembly including redistribution layer (RDL) substrate 500 bonded to the optic module 150 is bonded through package solder bonds 531 to a first side of a package substrate 537. The bonding may be by flip chip bonding (FCB). The package substrate 537 may be a cored substrate or a non-cored substrate. In some embodiments, the package substrate 537 may be a printed circuit board (PCB). A printed circuit board (PCB) is an electronic assembly that uses copper conductors to create electrical connections between components. In some embodiments, the PCB employed for the packaging substrate 537 may be built from alternating layers of conductive copper with layers of electrically insulating material. In some embodiments, the package substrate 537 may be a semiconductor material substrate, such as a type IV or type III-V semiconductor substrate. In one example, the package substrate 537 may be formed of a silicon containing material, e.g., a silicon (Si) substrate, or a germanium containing material, e.g., a silicon germanium (SiGe) substrate.

After the formation of the solder bumps 529 (as depicted in FIG. 22), the assembly including redistribution layer (RDL) substrate 500 bonded to the optical module 150 is flipped and the solder bumps 529 are aligned with contact pads (also referred to as bond pads) to the metal interconnect lines of the package substrate 537. In some embodiments, the accuracy of alignment may be of the order of a few microns for reliable function. In some embodiments, the assembly of the redistribution layer (RDL) substrate 500 and the optical module 150 is aligned and flipped on the package substrate 537, and the solder bumps 529 are reflowed to spread the conductive material evenly across the bond pads of the package substrate 537 forming package solder bonds 531, as depicted in FIG. 20. In some embodiments, the packaging solder bonds 131 may also be referred to as a ball grid array (BGA).

Additionally, an underfill (not shown) may be formed between the redistribution layer (RDL) substrate 500 and the package substrate 537. The underfill may also be referred to as a chip on wafer (COW) molding. The underfill may be deposited on the edges of the redistribution layer (RDL) substrate 500, so that it flows across the gap between the redistribution layer (RDL) substrate 500 and the package substrate 537 by capillary action, filling the space between the package solder bonds 531. The transfer substrate 207 may be removed. The packaging is not limited to only three-dimensional packaging, in which the EIC die 200, the PIC die 250 and the modulator module 300 are stacked in a vertical stack, as depicted in FIG. 20.

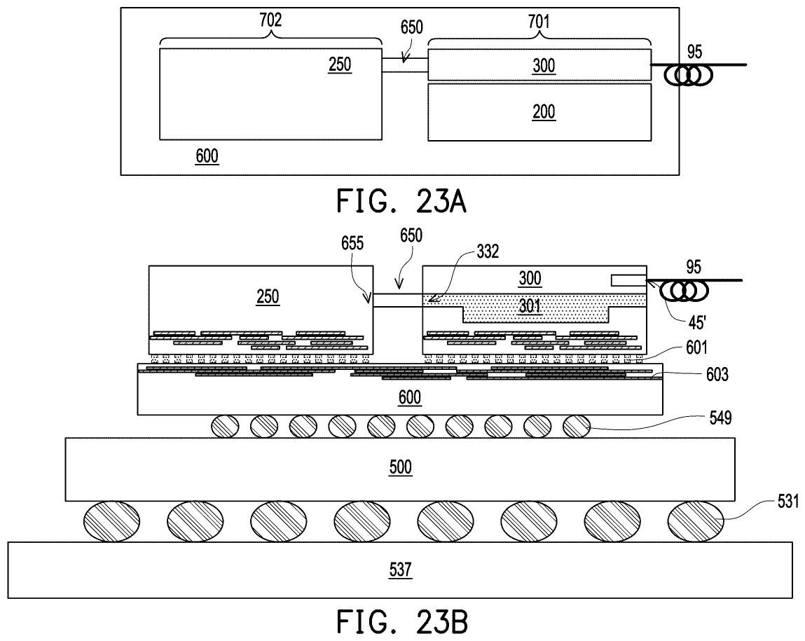

FIGS. 23A and 23B illustrate an embodiment of an optical module including an EIC die 200, a PIC die 250, and a modulator module 300 that is packaged in a 2.5-dimensional (2.5D) electro optical package. FIGS. 23A and 23B illustrate an overall view of a 2.5D heterogeneously integrated optical transceiver. In the embodiment depicted in FIGS. 23A and 23B, the PIC die 250, the modulator module 300, e.g., interposed TFLN modulator, and the EIC die 200 are co-plane and heterogeneously integrated on an interposer substrate 600, e.g., a Si, organic, or glass interposer. FIG. 23A is a top down view, whereas FIG. 23B is a side cross-sectional view. Referring to FIG. 23A, the modulator module 300 is integrated with the EIC die 200 in a side by side arrangement. More particularly, the modulator module 300 is bonded to a first portion of an interposer substrate 600, the PIC die is bonded to a second portion of the interposer substrate 600, and the EIC die is bonded to a third portion of the interposer substrate 600. In the embodiment depicted in FIG. 23A, the first and third portions of the interposer substrate 600 that the modulator module 300 and the EIC die 200 are bonded to are in a first region 701 of the interposer substrate 600. In the embodiment depicted in FIG. 23A, the second portion of the interposer substrate 600 that the PIC die 250 is bonded to is in a second region 702 of the interposer substrate 600. The first region 701 and the second region 702 of the interposer substrate 600 are adjacent to each other.

Referring to FIGS. 23A and 23B, a light coupling pathway between the PIC die 250 and the modulator 301 of the modulator module 300, e.g., interposed TFLN module, is through an interface waveguide 650 that is connected to the modulator module 300 and the PIC die 250. The interface waveguide 650 transmits light between the modulator module 300 and the PIC die 250. The interface waveguide 650 may receive optical signal from a waveguide portion 332 of the modulator 301 and may transmit optical signal to the PIC die through an interface PIC edge coupler 655. The interface waveguide 650 and the interface PIC edge coupler 655 may each be composed of silicon nitride, polysilicon and/or a polymeric material. The waveguide portion 332 of the modulator 301 may be composed of lithium niobate.

The electro-optical package that is depicted in FIGS. 23A and 23B further includes an interposer substrate 600 between the redistribution layer (RDL) substrate 500 and the PIC die 250, the EIC die 200, and the modulator module 300. Further, the PIC die 250, the EIC die 200 and the modulator module 300 may be bonded to the interposer substrate 600 using first interposer bonds 601 provided by microbumps, direct bonding (copper-to-copper bonding) and/or hybrid bonding.

In some embodiments, the interposer substrate 600 features at least one redistribution layer (RDL) and at least one through insulator via (TIV) (also referred to through InFO via) for providing electrical communication between dies, e.g., the modulator module 300, the EIC die 200 and the PIC die 250. In some examples, a local silicon interconnect (LSI) chip may also be included in the interposer substrate 600 for die-to-die interconnects for power and signal delivery. The circuitry of the interposer substrate 600 can also provide for interconnectivity of the PIC die 250, the EIC die 200 and the modulator module 300 to the redistribution layer (RDL) substrate 500 that is bonded to the opposing side of the interposer substrate 600. The circuitry of the interposer substrate 600 may be collectively referred to as interposer interconnect lines 603.

The first interposer bonds 601 between the upper surface of the interposer substrate 600 and the PIC die 250, the EIC die 200, and the modulator module 300 may be provided by microbump solder bonds, hybrid bonding and/or direct bonding. Direct bonding may be provided using copper-to-copper bonding. The copper-to-copper bonding method involves directly bonding copper connections between stacked structures, e.g., the PIC die 250 and the interposer substrate 600, the EIC die 200 and the interposer substrate 600, and the modulator module 300 and the interposer substrate 600. The copper connections that are bonded together may include copper pads in each of the structures being bonded together, e.g., the interposer substrate 600 and the modulator module 300/EIC die 200/PIC die 250. In some embodiments, the first interposer bonds 601 provided by copper to copper bonding allows for higher density and improved performance compared to methods like solder bumps and pillars.

In some embodiments, the copper-to-copper bonding method can include preparing the surfaces of the copper pads on each die, e.g., the modulator module 300, the EIC die 200, the PIC die 250 and the interposer substrate 400, are prepared and cleaned to ensure a strong bond. The copper-to-copper bonding method also includes aligning the dies so that the copper pads on each die (the modulator module 300, the EIC die 200, the PIC die 250 and the interposer substrate 600) match up perfectly. In a following process sequence, the copper-to-copper bonding method involves the dies (the modulator module 300, the EIC die 200, the PIC die 250 and the interposer substrate 600) being pressed together, and the copper pads bond through a process of diffusion, creating a direct electrical connection. In some embodiments, the first interposer bonds 601 provided by the copper-to-copper bonding can be achieved with bond pads as small as 0.25 μm at a pitch of 0.5 μm. In some embodiments, dielectric material between the bond pads of each of the structures being bonded to one another also form bonds when brought into contact with one another during the process by which the copper-to-copper bonds form. The bonding resulting from the copper-to-copper bonds and the dielectric material to dielectric material bonds results in a hybrid bond.

In some other embodiments, the first interposer bonds 601 between the modulator module 300, the EIC die 200, the PIC die 250 and the interposer substrate 600 may be provided by microbumps. A microbump process includes forming raised metal bumps on the bonding surfaces of the modulator module 300, the EIC die 200, the PIC die 250 and the interposer substrate 600, which act as electrical connection points for connecting multiple chips or layers within an integrated circuit package, allowing for high-density interconnections and enabling 3D stacking. In some embodiments, the microbumps that provides the first interposer bonds 601 may be composed of metals like copper, with a solder cap for improved reliability. In some embodiments, methods for forming the microbumps include electroplating, photolithography, and screen printing. In some embodiments, the microbumps may have a diameter ranging from 20 microns to 30 microns.

In some embodiments, the modulator module 300, the EIC die 200 and the PIC die 250 are first bonded to the interposer substrate 600 to provide a chip on interposer structure. Thereafter, the chip on interposer structure is bonded to a redistribution layer (RDL) substrate 500. In some embodiments, the first interposer bonds 601 between the interposer substrate 600 and the modulator module 300/EIC die 200/PIC die 250 may be copper to copper direct bonding or microbump bonding. After forming the first interposer bond 601 between the interposer substrate 600 and the module modulator 300/EIC die 200/PIC die 250, underfill and encapsulate may be applied, as described for the embodiment depicted in FIGS. 20-22.

The chip on interposer structure including the modulator module 300, the EIC die 200 and the PIC die 250 that is bonded to the interposer substrate 600 may then be bonded to a redistribution layer (RDL) substrate 500. The redistribution layer (RDL) substrate 500 that is depicted in FIGS. 23A and 23B is similar to the redistribution layer (RDL) substrate 500 that has been described above with reference to FIGS. 20-22. The second interposer bonds 549 for bonding the chip on interposer structure including the modulator module 300, the EIC die 200 and the PIC die 250 to the redistribution layer (RDL) substrate 500 may be copper to copper direct bonding or microbump bonding. After the chip on interposer structure is bonded to the redistribution layer (RDL) substrate 500, the entire assembly may then be bonded to the packaging substrate 537.

FIGS. 23A and 23B illustrate that the redistribution layer (RDL) substrate 500 is bonded to a packaging substrate 537. The packaging substrate 537 that is depicted in FIGS. 23A and 23B has been described above with reference to FIGS. 20-22. The package solder bonds 531 between the redistribution layer (RDL) substrate 500 and the packaging substrate 537 may be provided by solder bumps, such as C4 solder bumps. In some embodiments, solder bumps are formed on contacts to the one or more metal interconnect lines 514 of the redistribution layer (RDL) substrate 500. The package solder bonds 531 employed to bond the redistribution layer (RDL) substrate 500 to a package substrate 537 that are depicted in FIGS. 23A and 23B are similar to the package solder bonds 531 used to bond the optical module 150 to the redistribution layer (RDL) substrate 500 that is depicted in FIGS. 20-22. Therefore, the description of the package solder bonds 531 depicted in FIG. 20-22 is suitable for describing forming the package solder bonds 531 depicted in FIGS. 23A and 23B.

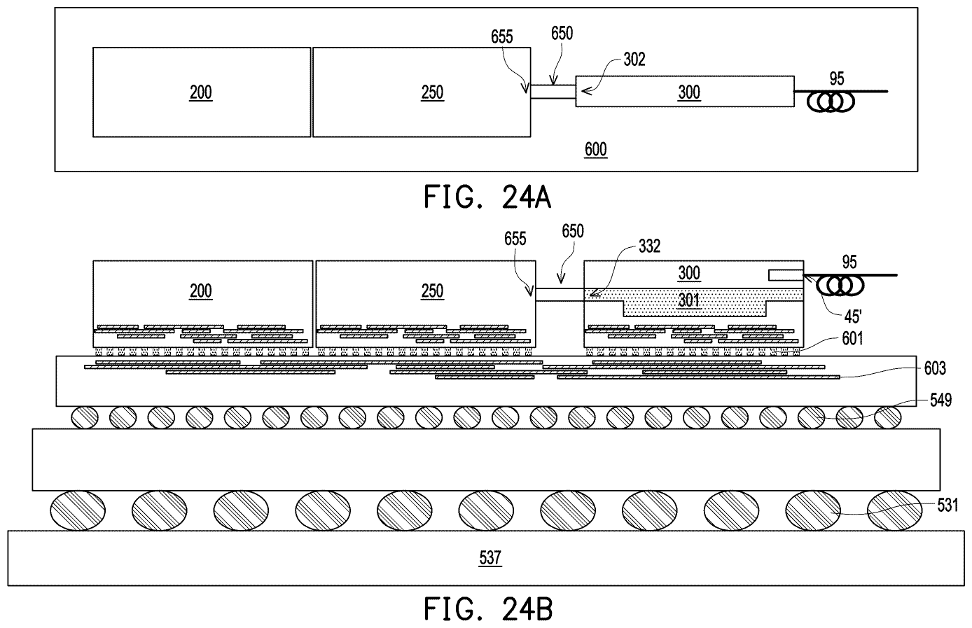

FIGS. 24A and 24B depict yet another 2.5D heterogeneously integrated optical transceiver. Similar to the embodiment depicted in FIGS. 23A and 23B, in the embodiment illustrated in FIGS. 24A and 24B, the PIC die 250, the modulator module 300, and the EIC die 200 are co-plane and heterogeneously integrated on a Si, organic, or glass interposer. However, in the embodiment that is depicted in FIGS. 24A and 24B, the PIC die 250 is in between the modulator module 300 and EIC die 200. Referring to FIGS. 24A and 24B, the modulator module 300, the PIC die 250 and the EIC die 200 have been arranged to be “in-line”.

In some embodiments, the methods and structures described herein can provide a number of advantages. The electro optical devices depicted herein are capable of achieving modulation frequency that are greater than 100 GHz (>400 Gbps), which enable significantly higher optical transceiver data rate and energy efficiency when compared to devices limited in modulation frequency to 50 GHz or 200 Gbps. Contamination concerns are limited by the packaging methods illustrated herein. The methods and structures described herein are flexible and configurable for coupling continuous light wave to ultra-high-frequency modulators. The methods and structures described herein are flexible and configurable for coupling modulated light signals to Si photonics circuits in the photonics integrated circuit (PIC) die. The methods and structures described herein provide for a high electrical interconnect bandwidth between the modulator and electrical driver in the electrical integrated circuit (EIC) die. The methods and structures described herein are applicable to light coupling by either edge coupler or grating coupler. The methods and structures described herein, are applicable to either Mach-Zehnder type or Micro-Ring type of TFLN modulator.

In accordance with an embodiment, a method comprising: forming a modulator onto a modulator interposer to provide a modulator module; bonding a Photonic Integrated Circuit (PIC) die to the modulator module to provide an optical module that is vertically stacked; and
bonding the optical module to a packaging substrate. In an embodiment, the optical module further comprises an Electrical Integrated Circuit (EIC) die that is bonded to the PIC die. In an embodiment, the modulator comprises lithium niobate. In an embodiment, the PIC die comprises an edge coupler. In an embodiment, the modulator module comprises an edge coupler. In an embodiment, the PIC die includes a grating coupler.

In another embodiment, a method comprising forming a modulator onto a modulator interposer to provide a modulator module; bonding the modulator module to a first portion of a redistribution layer (RDL) substrate, wherein the RDL substrate includes redistribution interconnect lines; bonding a Photonics Integrated Circuit (PIC) die to a second portion of the RDL substrate, wherein an optical signal pathway between the PIC die and the modulator module is a provided by a waveguide connected to the modulator module and the PIC die ; and bonding an Electrical Integrated Circuit (EIC) die to a third portion of the RDL substrate, wherein electrical signal between the EIC die and the PIC die is through the redistribution interconnect lines of the RDL substrate; and bonding the RDL substrate to a packaging substrate. In an embodiment, the modulator comprises lithium niobate. In an embodiment, the second portion of the RDL substrate that the PIC die is bonded to is between the first portion of the RDL substrate that the modulator module is bonded to and the third portion of the RDL substrate that the EIC die is bonded to. In an embodiment, the third portion of the RDL substrate that the EIC die is bonded to is in a first region of the RDL substrate that also includes the first portion of the RDL substrate that the modulator module is bonded, and the second portion of the RDL substrate that the PIC die is bonded to is in a second region of the RDL substrate, wherein the first region and the second region of the RDL substrate are adjacent to each other. In an embodiment, the modulator module comprises an edge coupler. In an embodiment, the edge coupler comprises silicon nitride.

In yet another embodiment, a device comprising an interposed modulator including a modulator on modulator interposer and a dielectric layer over the modulator; a Photonic Integrated Circuit (PIC) die having a waveguide for optical communication between the interposed modulator and the PIC die; and an Electrical Integrated Circuit (EIC) die in electrical communication with the PIC die and the interposed modulator through bonded interfaces. In an embodiment, interposed modulator comprises an edge coupler. In an embodiment, the modulator comprises lithium niobate. In an embodiment, the modulator is a Mach-Zehnder modulator. In an embodiment, the modulator is a ring type modulator. In an embodiment, the PIC die is bonded to the interposed modulator, and the EIC die is bonded to the PIC die to provide a vertical stack of the EIC die, the PIC die and the interposed modulator. In an embodiment, the device further includes a redistribution layer (RDL) substrate, wherein the interposed modulator is bonded to a first portion of the RDL substrate, the PIC die is bonded to a second portion of the RDL substrate, and the EIC die is bonded to a third portion of the RDL substrate.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
forming a modulator onto a modulator interposer to provide a modulator module;
bonding a Photonic Integrated Circuit (PIC) die to the modulator module to provide an optical module that is vertically stacked; and
bonding the optical module to a packaging substrate.

2. The method of claim 1, wherein the optical module further comprises an Electrical Integrated Circuit (EIC) die that is bonded to the PIC die.

3. The method of claim 1, wherein the modulator comprises lithium niobate.

4. The method of claim 1, wherein the PIC die comprises an edge coupler.

5. The method of claim 1, wherein the PIC die comprises a grating coupler.

6. The method of claim 1, wherein the modulator module comprises an edge coupler.

7. The method of claim 6, wherein the edge coupler comprises silicon nitride.

8. A method comprising:
forming a modulator onto a modulator interposer to provide a modulator module;
bonding the modulator module to a first portion of a redistribution layer (RDL) substrate, wherein the RDL substrate includes redistribution interconnect lines;
bonding a Photonics Integrated Circuit (PIC) die to a second portion of the RDL substrate, wherein an optical signal pathway between the PIC die and the modulator module is a provided by a waveguide connected to the modulator module and the PIC die; and
bonding an Electrical Integrated Circuit (EIC) die to a third portion of the RDL substrate, wherein an electrical signal path between the EIC die and the PIC die is through the redistribution interconnect lines of the RDL substrate; and
bonding the RDL substrate to a packaging substrate.

9. The method of claim 8, wherein the modulator comprises lithium niobate.

10. The method of claim 8, wherein the second portion of the RDL substrate that the PIC die is bonded to is between the first portion of the RDL substrate that the modulator module is bonded to and the third portion of the RDL substrate that the EIC die is bonded to.

11. The method of claim 8, wherein the third portion of the RDL substrate that the EIC die is bonded to is in a first region of the RDL substrate that also includes the first portion of the RDL substrate that the modulator module is bonded, and the second portion of the RDL substrate that the PIC die is bonded to is in a second region of the RDL substrate, wherein the first region and the second region of the RDL substrate are adjacent to each other.

12. The method of claim 8, wherein the modulator module comprises an edge coupler.

13. The method of claim 12, wherein the edge coupler comprises silicon nitride.

14. A device comprising:
an interposed modulator including a modulator on modulator interposer and a dielectric layer over the modulator;
a Photonic Integrated Circuit (PIC) die having a waveguide for optical communication between the interposed modulator and the PIC die; and
an Electrical Integrated Circuit (EIC) die in electrical communication with the PIC die and the interposed modulator through bonded interfaces.

15. The device of claim 14, wherein the interposed modulator comprises an edge coupler.

16. The device of claim 14, wherein the modulator comprises lithium niobate.

17. The device of claim 14, wherein the modulator is a Mach-Zehnder modulator.

18. The device of claim 14, wherein the modulator is a ring type modulator.

19. The device of claim 14, wherein the PIC die is bonded to the interposed modulator, and the EIC die is bonded to the PIC die to provide a vertical stack of the EIC die, the PIC die and the interposed modulator.

20. The device of claim 14, further comprising a redistribution layer (RDL) substrate, wherein the interposed modulator is bonded to a first portion of the RDL substrate, the PIC die is bonded to a second portion of the RDL substrate, and the EIC die is bonded to a third portion of the RDL substrate.
